(19) United States
(12) Patent Application Publication
(10) Pub. No.: US 2010/0274902 A1
(43) Pub. Date: Oct. 28, 2010

(54) System and Method for N-Way Communication with and between Locking/Unlocking Morphing Game Peripherals

(76) Inventors: Douglas Penman, Ross, CA (US); Rodger Raderman, San Francisco, CA (US)

Correspondence Address: Stattler-Suh PC, 60 SOUTH MARKET, SUITE 480, SAN JOSE, CA, 95113, US

(21) Appl. No.: 12/505,120

(22) Filed: Jul. 17, 2009

Related U.S. Application Data
(60) Provisional application No. 61/172,068, filed on Apr. 23, 2009.

(51) Int. Cl. G06F 15/16

(52) U.S. Cl. 709/227

(57) ABSTRACT

A system and method for actuating a visible persistent physical change to a game peripheral during interaction with an online game server having multiple game states. The method includes steps for establishing a connection between a game peripheral and an online game server, associating the game peripheral with at least one game state, retrieving from the online game server at least one bit for downloading to the game peripheral, and actuating at least one electro-mechanical component of the game peripheral for morphing the game peripheral. Morphing of the game peripheral produces at least one visible persistent change to the game peripheral, including locking or unlocking components of the game peripheral, changing physical shape, or other mode of changing the visible appearance of the game peripheral. Some embodiments include a second game peripheral for communicating state to a first game peripheral, and actuating an electro-mechanical component of the first game peripheral.

### RELATED APPLICATION

The present application claims priority to application filed Apr. 23, 2009 under application Ser. No. 61/172,068, which is incorporated herein by reference for all purposes. However, insofar as any definitions, information used for claim interpretation, etc. from the abovementioned application conflicts with that set forth herein, such definitions, information, etc. in the present application should apply.

### FIELD OF THE INVENTION

The present invention is directed towards interoperative toys, and more particularly towards toys that interactively morph in response to online activity.

### BACKGROUND OF THE INVENTION

Broad and inexpensive availability of Internet communication as well as communication between inexpensive portable devices including toys has created an environment where such portable devices can be deployed broadly with highly specific purposes. Conceptually, such portable devices can include characteristics that change in visible ways in response to some particular Internet activity. In some environments, a toy might bear a resemblance or likeness or other relationship to an Internet character or theme. Concurrently, high-tech consumerism has lowered cost and adoption barriers for technologies that support wireless communication between small low-cost devices, and such devices facilitate learning or entertainment where an individual can interact with the device, and/or with other devices, and/or with or through the Internet. What is needed are systems and methods to allow online activities to be interactively coordinated with the physical characteristics of the toy.

### SUMMARY OF THE INVENTION

A system and method morphs a game peripheral during interaction with an online game server having multiple game states. Based on the state of game play or change in the state of game play, the game peripheral morphs in shape to reflect the game state, and retains that morphed state until another game state change. Game play is initiated by establishing a connection between the game peripheral (e.g. a badge or necklace or bracelet or other wearable accessories, or a character likeness, or a vehicle or weapon, etc), and the online game server. Once such a connection is established, the system associates the game peripheral with at least one game state by retrieving from the online game server some aspect of the state of game play, and uses the state of game play to morph the peripheral.

In some cases, the morphing is effected by actuating an electromechanical component of the game peripheral for morphing the game peripheral. For example, a game peripheral might emit some colored light (i.e. via LEDs or other light-emitting or light-modulating technique). In other embodiments, the morphing might be accompanied by physical changes to the game peripheral. For example, the game peripheral might comprise a series of interlocking parts, or even a series of successively enclosed components such as a “Russian Doll”.

In certain embodiments, game state includes states as determined or influenced by information retrieved from a second game peripheral. In certain embodiments, game state includes states as determined or influenced by information retrieved from one or more social networking sites.

### BRIEF DESCRIPTION OF THE DRAWINGS

A brief description of the drawings follows:

FIG. 1 depicts an exemplary online Internet gaming environment including a game server and morphing game peripherals.

FIG. 2 shows an exemplary embodiment of an online gaming environment including interactive morphing game peripherals in a peer-to-peer connection.

FIG. 3 is a block diagram of apparatus components of a system and method for n-way communication with and between locking/unlocking morphing game peripherals showing an actuator apparatus, according to one embodiment.

FIG. 4 is a block diagram of a game peripheral for use within a system for n-way communication with and between locking/unlocking morphing game peripherals, according to one embodiment.

FIG. 5A shows a concentric component physical design of a morphing game peripheral for use within a system for n-way communication with and between locking/unlocking morphing game peripherals, according to one embodiment.

FIG. 5B shows a successively revealing physical design of a morphing game peripheral for use within a system for n-way communication with and between locking/unlocking morphing game peripherals, according to one embodiment.

FIG. 5C shows a sliding component physical design of a morphing game peripheral for use within a system for n-way communication with and between locking/unlocking morphing game peripherals, according to one embodiment.

FIG. 5D shows a hinged component physical design of a morphing game peripheral for use within a system for n-way communication with and between locking/unlocking morphing game peripherals, according to one embodiment.

FIG. 5E shows a light-emitting physical design of a morphing game peripheral for use within a system for n-way communication with and between locking/unlocking morphing game peripherals, according to one embodiment.

FIG. 5F shows a light-emitting, concentric component physical design of a morphing game peripheral for use within a system for n-way communication with and between locking/unlocking morphing game peripherals, according to one embodiment.

FIG. 5G shows a protruding component physical design of a morphing game peripheral for use within a system for n-way communication with and between locking/unlocking morphing game peripherals, according to one embodiment.

FIG. 5H shows a successively revealing, hinged, concentric component physical design of a morphing game peripheral for use within a system for n-way communication with and between locking/unlocking morphing game peripherals, according to one embodiment.

FIG. 5I shows a removable component physical design of a morphing game peripheral for use within a system for n-way communication with and between locking/unlocking morphing game peripherals, according to one embodiment.

FIG. 5J shows a light-emitting, arrayed component physical design of a morphing game peripheral for use within a system for n-way communication with and between locking/unlocking morphing game peripherals, according to one embodiment.

FIG. 5K shows an arrayed light-emitting, protruding component physical design of a morphing game peripheral for use within a system for n-way communication with and between locking/unlocking morphing game peripherals, according to one embodiment.

FIG. 5L shows a sliding, protruding component physical design of a morphing game peripheral for use within a system for n-way communication with and between locking/unlocking morphing game peripherals, according to one embodiment.

FIG. 5M shows an arrayed hinged component physical design of a morphing game peripheral for use within a system for n-way communication with and between locking/unlocking morphing game peripherals, according to one embodiment.

FIG. 5N shows a successively revealing physical design of a morphing game peripheral for use within a system for n-way communication with and between locking/unlocking morphing game peripherals, according to one embodiment.

FIG. 5O shows a keyed successively revealing physical design of a morphing game peripheral for use within a system for n-way communication with and between locking/unlocking morphing game peripherals, according to one embodiment.

FIG. 5P shows a successively revealing physical design of a morphing game peripheral for use within a system for n-way communication with and between locking/unlocking morphing game peripherals, according to one embodiment.

FIG. 6 depicts exemplary online interactions between morphing game peripherals, a game platform, and a game server.

FIG. 7 depicts a hierarchy of modes and operations under a morphing game peripheral that may interoperate with a game server or a social network server or a virtual world server, according to one embodiment.

FIG. 8 is a depiction of methods for use within a system for n-way communication with and between locking/unlocking morphing game peripherals, according to some embodiments.

FIG. 9 is a depiction of a system and method for n-way communication between multiple morphing game peripherals, and a game server, according to one embodiment.

FIG. 10 is a diagrammatic representation of a machine in the exemplary form of a computer system, within which a set of instructions may be executed, according to according to one embodiment.

### DETAILED DESCRIPTION

In the following description, numerous details are set forth for purposes of explanation. However, one of ordinary skill in the art will realize that the invention may be practiced without the use of these specific details. In other instances, well-known structures and devices are shown in block diagram form in order to not obscure the description of the invention with unnecessary detail.

Methods and systems disclosed herein embody devices or toys for sensor-initiated game play experiences, coordinated “offline” and “online” game play, and audio and video feedback. Some embodiments include moving parts, configuration manipulation, and robotics. Embodiments include devices capable of powering a wide variety of toy executions, and lend features and capabilities for game designers and toy designers to integrate into new and existing online virtual worlds and games. Imagine . . . . Your virtual pet is hungry. You feed it online, and the real world toy version of the pet sitting beside you burps. Online, you are on a mission to locate a secret artifact, and your “offline” toy interacts with the real world and virtual worlds along the way, providing hints and clues in real-time. You invite a friend over who also owns a toy—it automatically connects you with him in an online world. Imagine . . . A boy takes his online status via his toy offline into the schoolyard. He challenges his friend to a wireless mini-game and wins some of his friend's currency. When he returns to the computer, his currency is increased and his friend's is likewise decreased. As a further example, imagine that you have a toy representative of your online avatar next to your computer, and your friend across town has one as well. You tickle your friend's on-screen avatar, and your friend's toy giggles and wiggles even though your friend's toy is located clear across town. Even more, imagine playing a Disney “Fairies” online game. Upon completion of a particular level in the virtual world of the online game, your toy fairy's wings are unlocked and morph into a splayed configuration. Alternatively, imagine a morphing toy that is lockable/unlockable into a “Russian Doll” toy form factor. As interaction with the online game continues, successive layers of the Russian Doll keep unlocking at each level or milestone in the game until a specific level or milestone is reached and the prize within the centermost doll is unlocked and revealed. Further examples include a lockable/unlockable puzzle in a form factor of a cube that sheds outer puzzle pieces in order to reach the ‘hidden’ prize within, or a toy that morphs in synchrony with happenings in the virtual world (e.g. in synchrony with achievement of milestones in the virtual world), thus changing its shape and likeness into distinctive characters as corresponds to the specific happenings in the virtual world.

Various features of some embodiments allow a player to establish and maintain an online reputation, and exhibit that reputation with others via both online worlds and in the real world. Other embodiments include a proximity locator that might automatically connect with friends, (and other interoperative toys), play mini-games (whether connected online or not), and wirelessly update status and other information when an uplink is available. Further features of some embodiments allow a player to establish and maintain lists of online friendships, and exhibit some, none, or all of those friendships with others via both online world interfaces as well as (optionally) in the real world. In particular, some embodiments include a proximity locator that might automatically connect with friends (and their interoperative toys), identify friends (whether connected online or not), and wirelessly update friendships and other information when an uplink is available. Of course, in both gaming/online worlds as well as in the real world, a friend may be a friend to varying degrees, even to the point of being a foe. In some situations online/game entities (whether a real person or strictly a gaming/online/virtual entity) may be intrinsically a foe (e.g. as related to a game situation). Similarly a real person may be deemed to be a foe (or alternatively a friend to some degree, or a friend, but of unknown trust level, etc) and such a designation may be controlled in some dimensions by a player, and/or in some dimensions by user or parental control.

### Description of the Environment

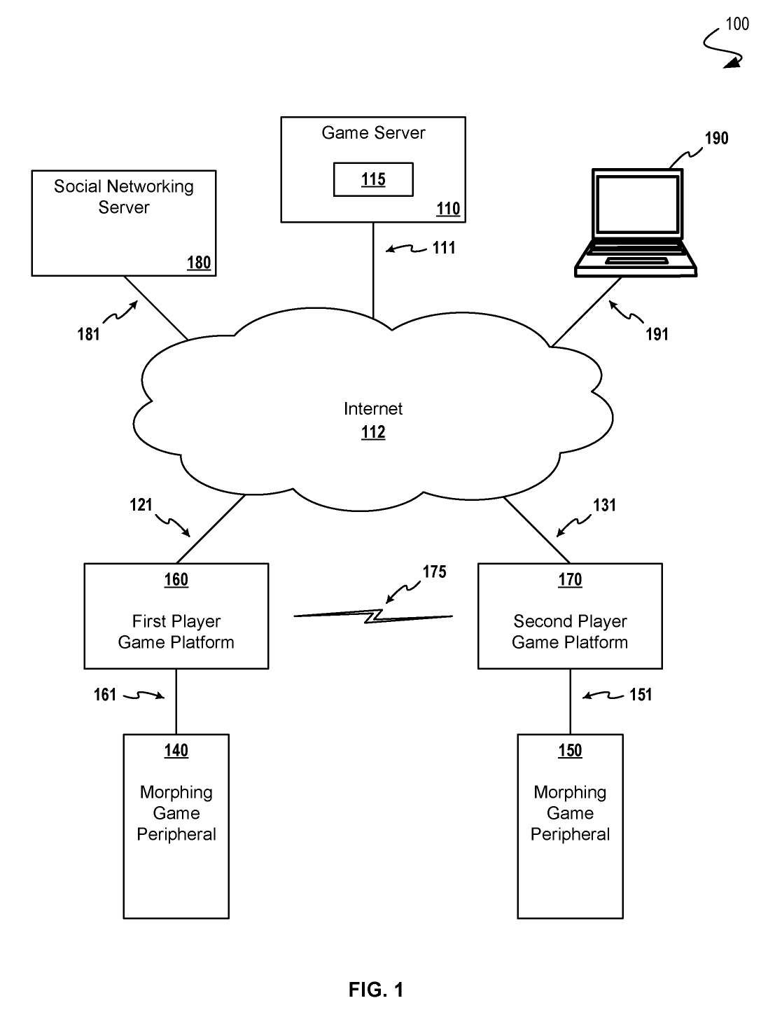

FIG. 1 depicts an exemplary online Internet gaming environment including an online social networking server. As shown in system 100, a game server 110, a social networking server 180, a control terminal 190, a first player game platform 160 (e.g. a game console, a PlayStation™, a Wii™, a personal computer, a Macintosh™ computer, an iPhone™, a networked device, even a network router, etc) and a second player game platform 170 connect to the internet 112 over communication links 111, 181, 191, 121, and 131, respectively. A morphing game peripheral 140 (e.g. a joystick, keypad, keyboard, transducer, etc) connects to a first player game platform 160 over communication link 161, and a morphing game peripheral 150 connects to a second player game platform 170 over communication link 151. Game play might be initiated by game software 115 executing on game server 110 (e.g. an online game server, a multi-player server, a virtual world server, etc), and one or more players may join in game play from a game platform. Online social interaction might be initiated by or with a social networking server 180, or by game software 115 executing on servers 180 and/or 110, respectively, and/or other servers (e.g. an online game server, a multi-player server, a virtual world server, a social networking feed server, etc), and one or more players may join in social interaction and/or game play from a game platform 160, 170.

Players interact with the game software resident on the server over a communication path through the Internet. In some situations, the game software 115 supports multi-player games, and interaction between players is supported via at least a network communication path from one player (e.g. a first player station 160) through communication link 121 to the Internet 112, through the communication link 111 to the game server 110, again to the Internet 112, and to a second or nth player operating game platform 170, through the communication link 131. In some situations, wireless communication is used for any of communication links 121 and 131 (and even communication link 111 for that matter). In fact, some environments support a wireless communication link 175 (e.g. 802.11b, 802.11g, 802.11n, etc) between two or more game platform systems (e.g. 160, 170), and some environments support one or more wireless routers.

However, while such an environment and configuration supports multi-player online play, and even in some cases the possibility for peer-to-peer communication (e.g. between a first player game platform and a second player game platform) over a wireless communication link 175, such a configuration is stationary. When a player moves away from the player's game platform (e.g. goes to school, goes to the mall, etc), then interaction between the player and the game software is interrupted as is interaction between a first player and a second player.

As earlier indicated, even when a player moves away from the player's game platform (e.g. goes to school, goes to the mall, etc), and interaction between the player and the game software is interrupted, there remains the possibility for peer-to-peer communication (e.g. between a first player's game peripheral and a second player's game peripheral) over a wireless peer-to-peer communication link (e.g. using any one or more of the aforementioned wireless communication links, or other communication mechanisms for that matter). Using such a peer-to-peer communication method between game peripherals, real world friendships may be established.

### Exemplary Embodiments of Morphing Game Peripherals

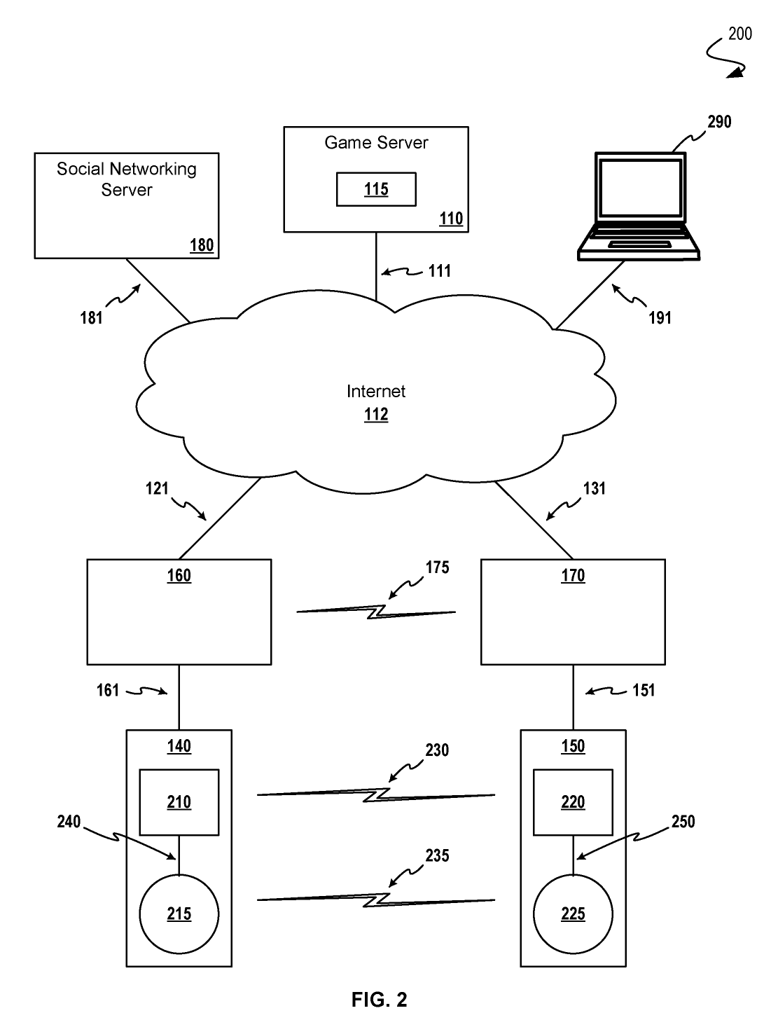

FIG. 2 shows an exemplary embodiment of an online gaming environment including interactive morphing game peripherals, and a terminal for control of social interactions. This embodiment of the invention is represented within the context of the online gaming environment of FIG. 1. As shown in the system 200, each game peripheral 140 and 150 respectively comprises a stationary component 210, 220 and a mobile component 215, 225. Referring to a first game peripheral 140, a communication link 240 provides for communicating between a stationary component 210 and a first mobile game peripheral component 215. Referring to a second game peripheral 150, a communication link 250 provides for communicating between a stationary component 220 and a second mobile game peripheral component 225. Referring to the juxtaposition of a first mobile game peripheral component 215 and a peer mobile game peripheral component 225, a wireless communication link 235 is provided. Furthermore, a peer (e.g. game peripheral component 215) can be removed (e.g. undocked, unplugged, disconnected) from game peripheral component 210. Some embodiments include a control terminal 190 (e.g. a personal computer, or a network computer, or any platform capable of rendering a web page, or any I/O device structure on or in a game peripheral component, etc). Also, some embodiments include communication by and between a social networking server 180 and a game server 110 through the Internet 112 via inter-process communication (e.g. feeds, push technologies, pull technologies, web services, HTTP, TCP/IP, etc).

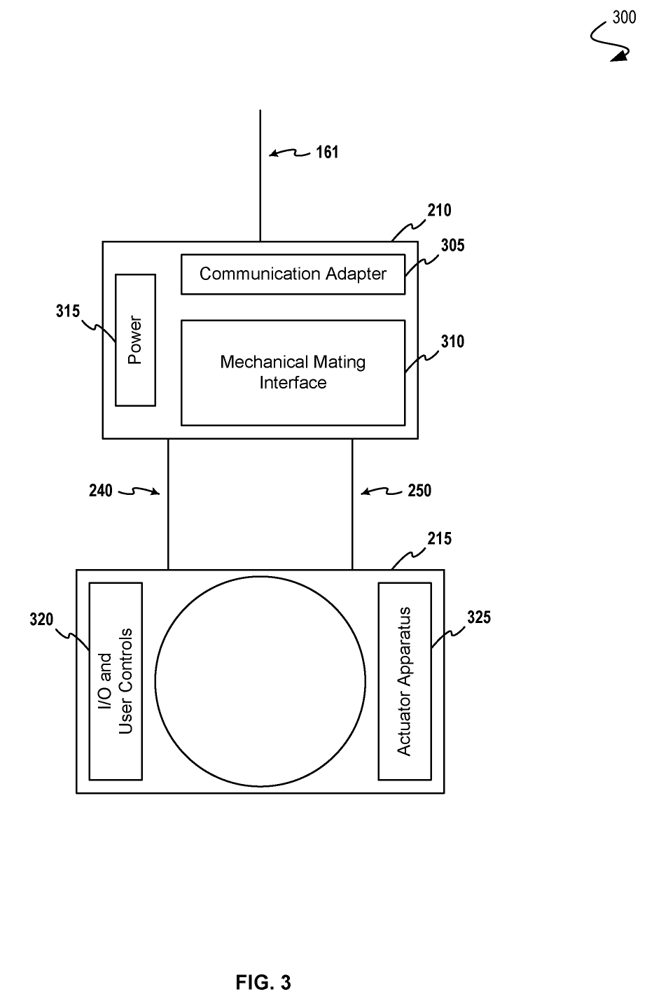

FIG. 3 is a block diagram of components of a system and method for n-way communication with and between locking/unlocking morphing game peripherals, according to one embodiment. As an option, the present system 300 may be implemented in the context of the architecture and functionality of FIG. 1 through FIG. 2. In particular, system 300 might be included in environments 100 or 200. Of course, however, the system 300 may be included in any desired environment. As shown, system 300 performs at least some of the operations of a morphing game peripheral 140. In particular, a stationary component 210 might comprise a communication adapter 305 (e.g. USB, Bluetooth, serial I/O, etc), a power subsystem 315 (e.g. a power conditioner, a charging unit, a power conductor, etc), and a mechanical mating interface 310 (e.g. cradle, sheath, connector, etc). The stationary component 210 includes a communication signal adapter 305, and a power harness 250 for carrying power between a stationary component 210 and a game peripheral component 215. Those skilled in the art will recognize that the component 210 might be embodied within a USB cable. Moreover, the game peripheral component 215 might include zero or more input and/or output structures 320 (e.g. a button, a touch screen, an LED, an RFID reader, a switch, etc) which might be used for input or output of user controls. In some embodiments user controls are realized as in-device structures 320 that might be used to capture user controls. Such capture of user controls might include cooperation with any online or web GUI accessible at least in part through a communication signal adapter 240. As shown, game peripheral component 215 includes an actuator apparatus 325, which comprise one or more electrical, or mechanical, or electromechanical actuators 480, 481, 482 that serve to morph the peripheral component 215 in such a manner that an individual can interact with the device, and/or with other devices, and/or with or through the Internet. For example, in the context of playing an Internet-based game, after finding a clue or reaching a milestone point in the Internet-based game, the peripheral component 215 might morph by becoming physically “unlocked”, revealing an additional clue within. Additional embodiments are discussed infra.

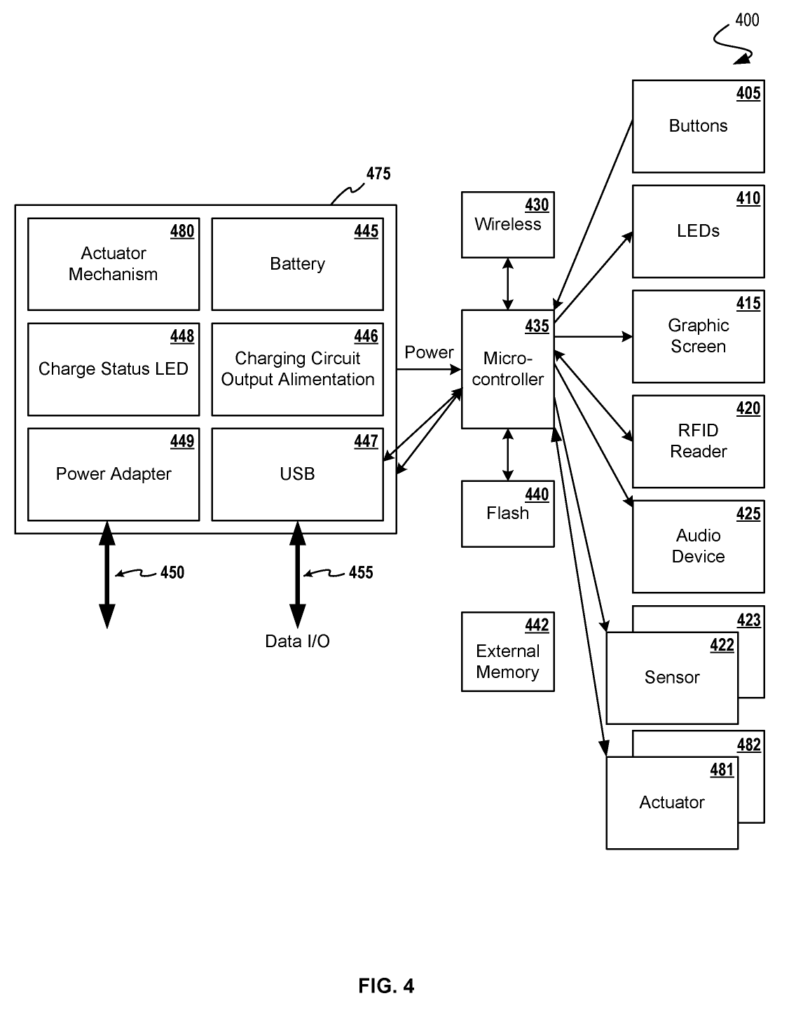

FIG. 4 is a block diagram of a game peripheral 140 for use within a system and method for n-way communication with and between locking/unlocking morphing game peripherals, according to one embodiment. As an option, the present system 400 may be implemented in the context of the architecture and functionality of FIG. 1 through FIG. 3. In particular, system 400 might be included in environments 100 or 200. Of course, however, the system 400 may be included in any desired environment. As per the exemplary implementation shown, the game peripheral includes a microcontroller 435 which may be embodied by any of a wide variety of microprocessors or microcontrollers (e.g. PIC processor, TINY processor, etc), which might include flash memory 440 as an integrated component, or might include an interface for flash memory, or both. The microcontroller might support an interface to any of a variety of external memory types and configurations; for example, for external memory 442. The microcontroller 435 might also support a variety of external devices. For example, commercially available microcontrollers often support a variety of serial and/or parallel devices through a general purpose I/O (GPIO) section. In some embodiments, the microprocessor might provide support (e.g. hardware or software, or both) interfaces to human interface devices such as buttons (e.g. momentary switches, capacitive switches, photocells, etc) 405, electrically actuated visible indicators (e.g. light emitting diodes, LEDs, etc) 410, graphic screens (e.g. an LCD screen, a VGA screen, a touch-screen, etc) 415, and/or audio devices (e.g. a buzzer, a speaker, piezoelectric transducers, electrostatic transducers, mechanical actuators, etc) 425. In some cases, including embodiments disclosed infra, the microcontroller 435 might support functions for, or interfaces to, wireless transceivers (e.g. 802.11b, 802.11g, 802.11n, etc) 430 and/or to other wireless transceivers or devices (e.g. infrared, piezoelectric emitters, proximity sensors, etc) 430 and/or to RFID readers 420, and/or to one or more sensors 422, 423 for carrying out sensing operations discussed herein. Still more, the microcontroller 435 might interface directly or indirectly to a universal serial bus (USB) component 447 or any other known-in-the-art interface suitable to communicate with a personal computer or game console, or with a game console embodied within a personal computer, or with any other computing device configured to present a user interface, which communication is supported by data I/O bus 455. As regards the subsystem 475, morphing game peripherals might contain one or more actuator mechanisms 480 coupled to one or more actuators 481, 482. Some embodiments of subsystem 475 might include a battery 445 or other device for storing or generating a charge (e.g. a capacitor, a solar collector, a fuel cell, etc), and the power subsystem might include human interfaces 448 (e.g. an LED) for discerning the state of the power subsystem, and might include charging circuits 446 (e.g. charging circuit output alimentation), power connector adapters 449, and electrical conductors 450 suited for carrying current used in providing power to various portions of the system 400. Those skilled in the art will recognize that the flash memory 440 might be used to retain microprocessor software instructions, and/or configuration data, and/or the game play state, and/or the state regarding the player's social relationships, social interactions, and social interaction restrictions, even including user settings.

### Exemplary Configurations of Morphing Game Peripheral Actuators

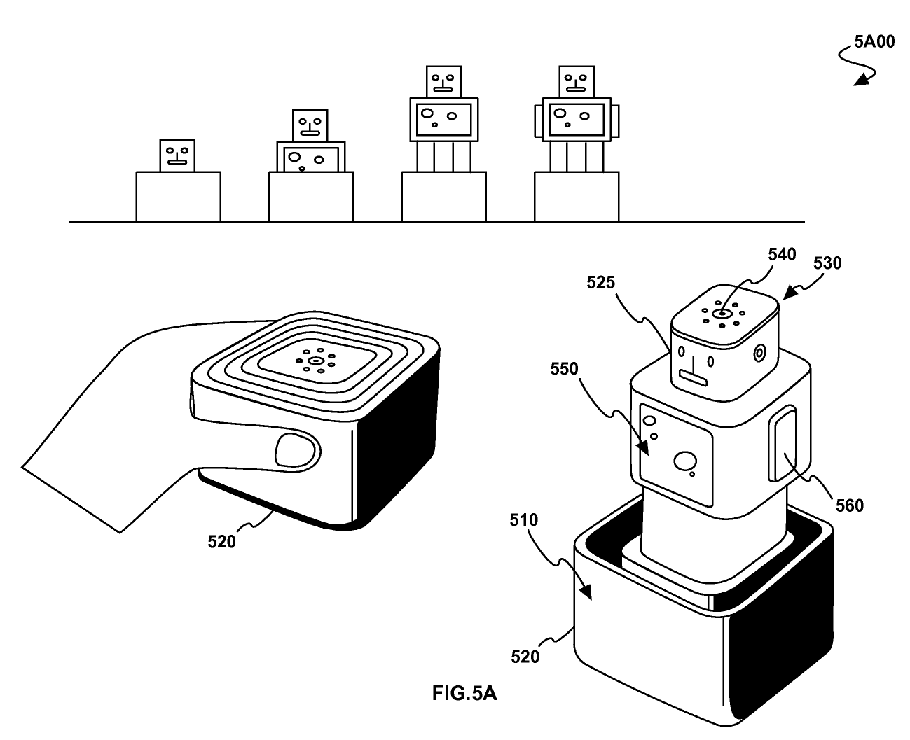

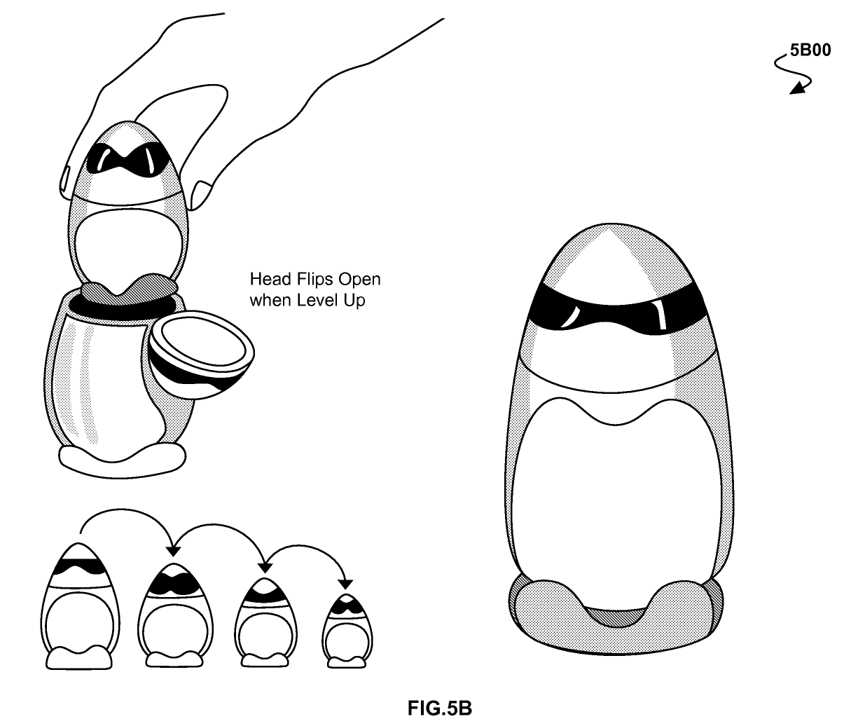

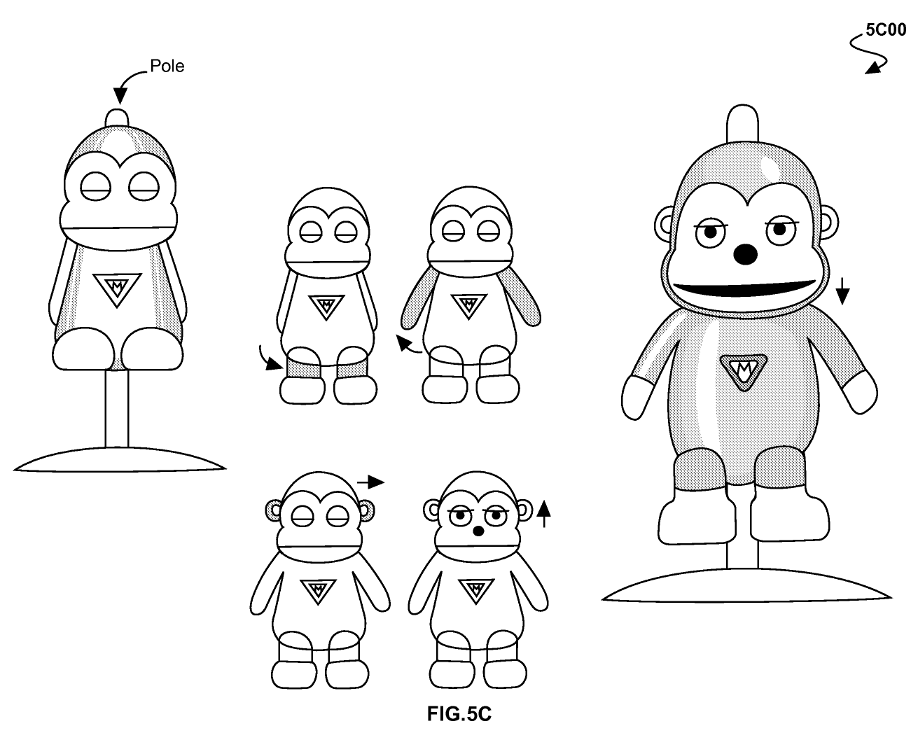

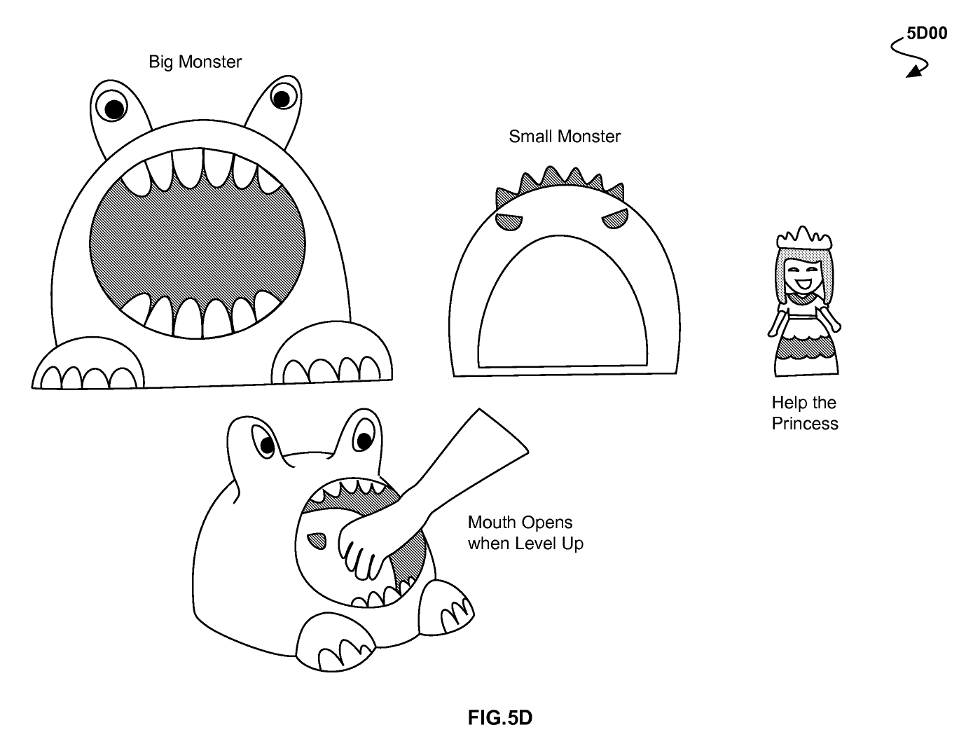

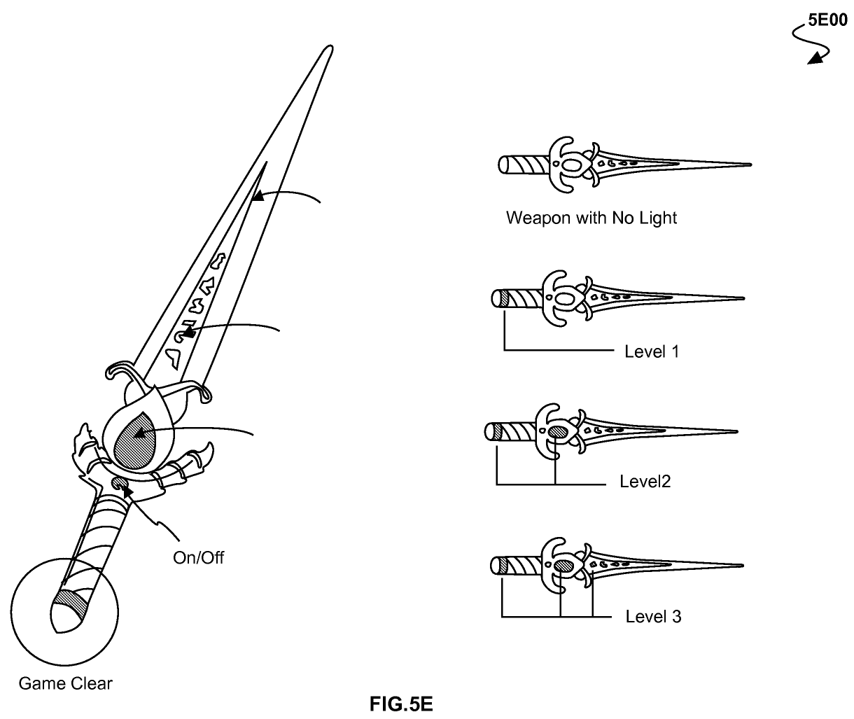

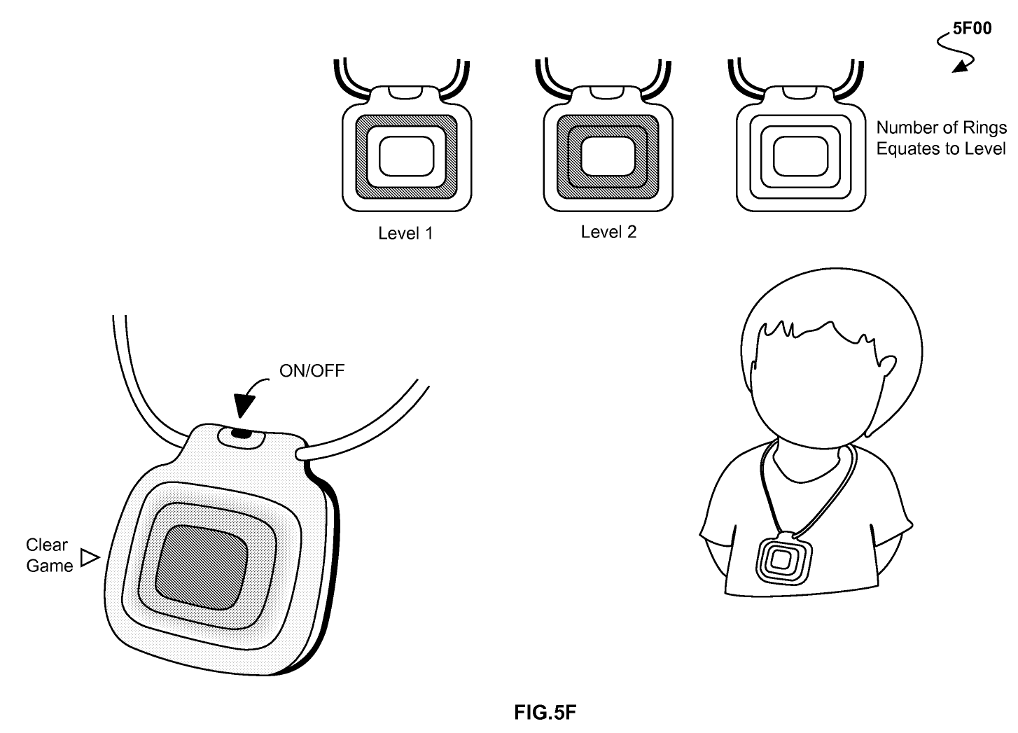

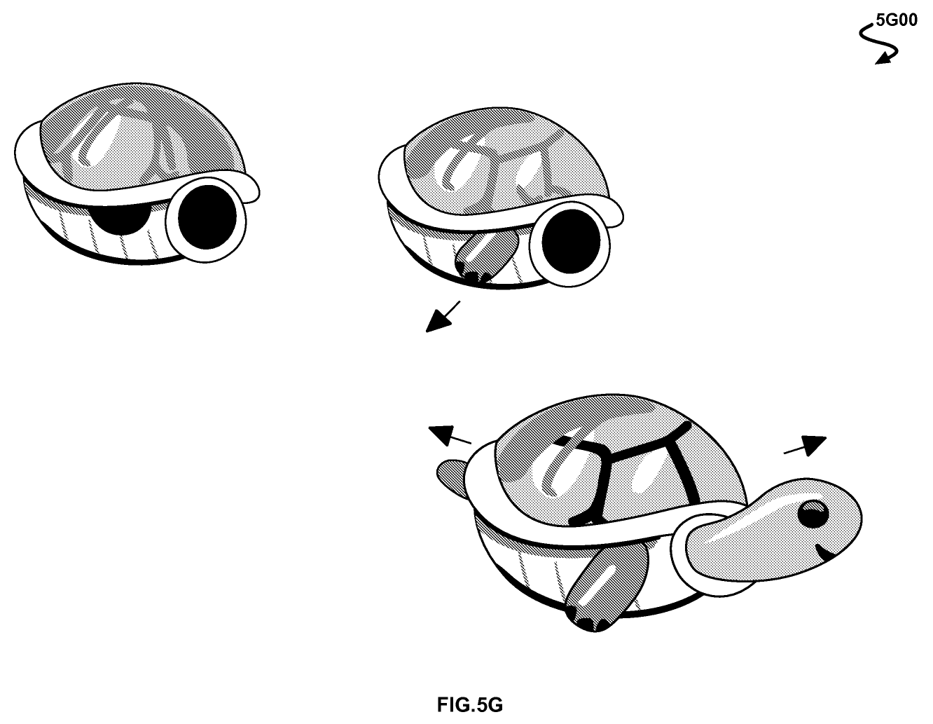

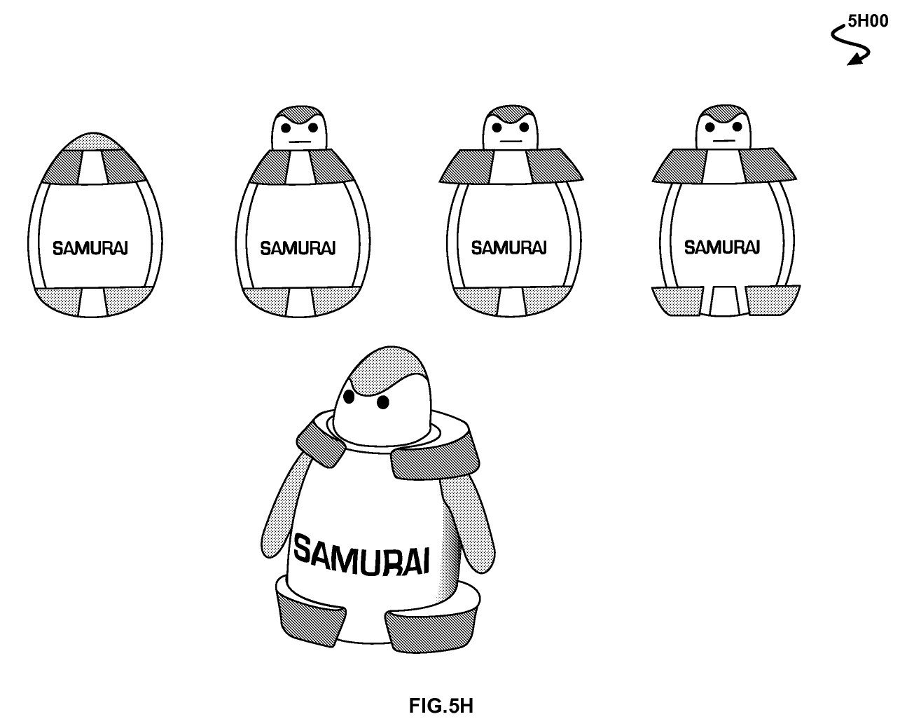

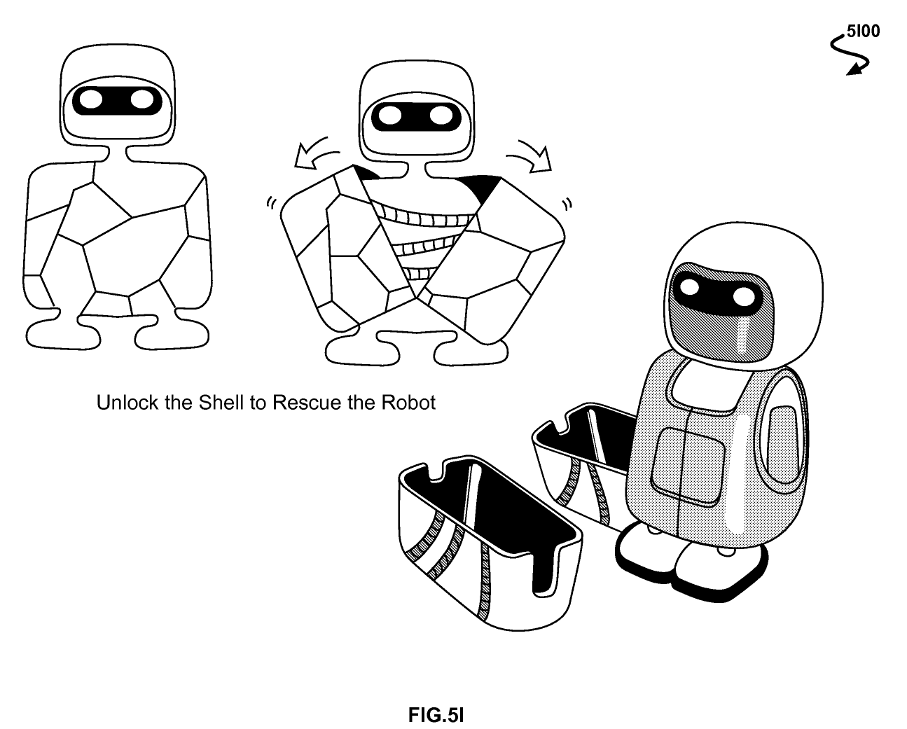

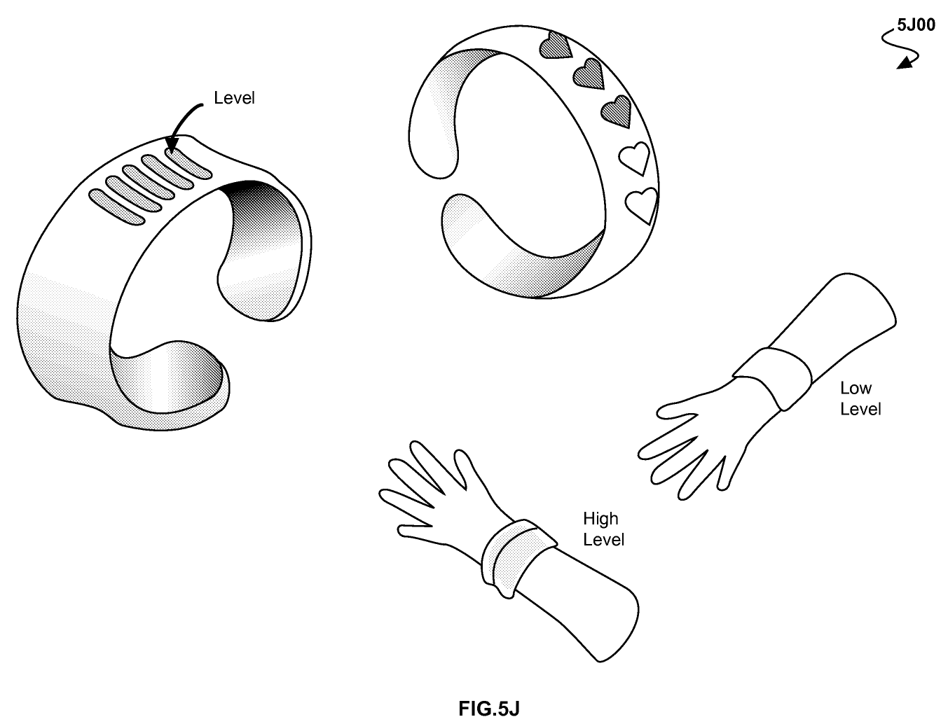

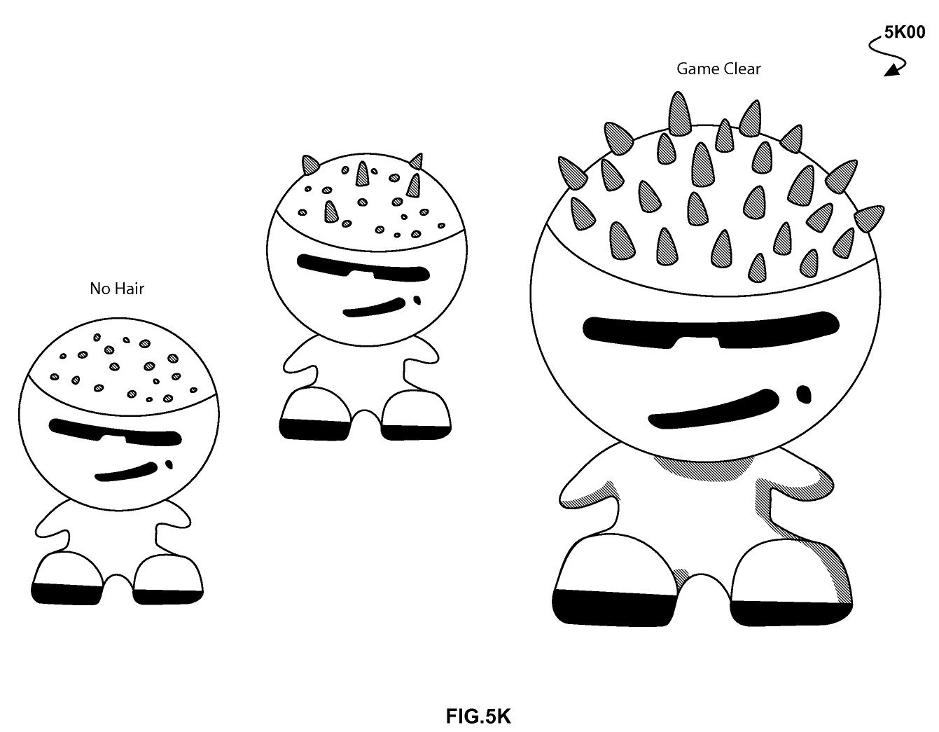

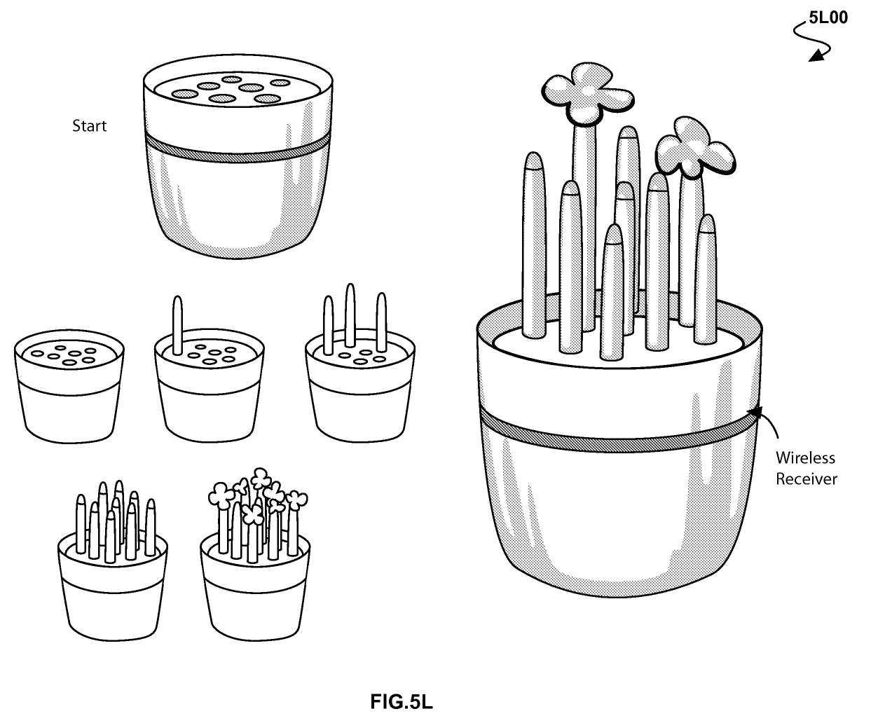

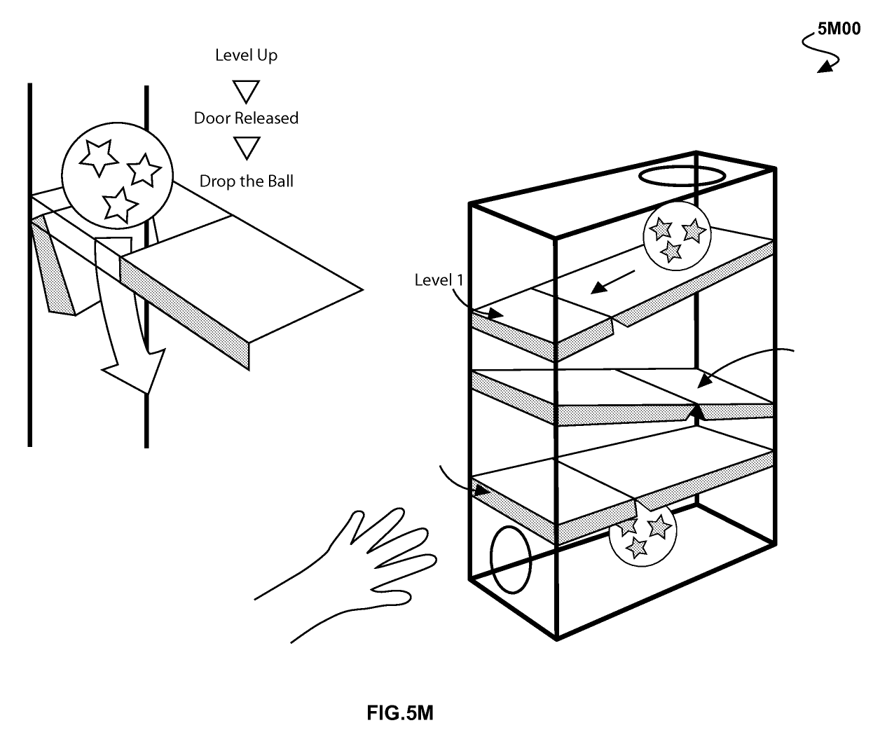

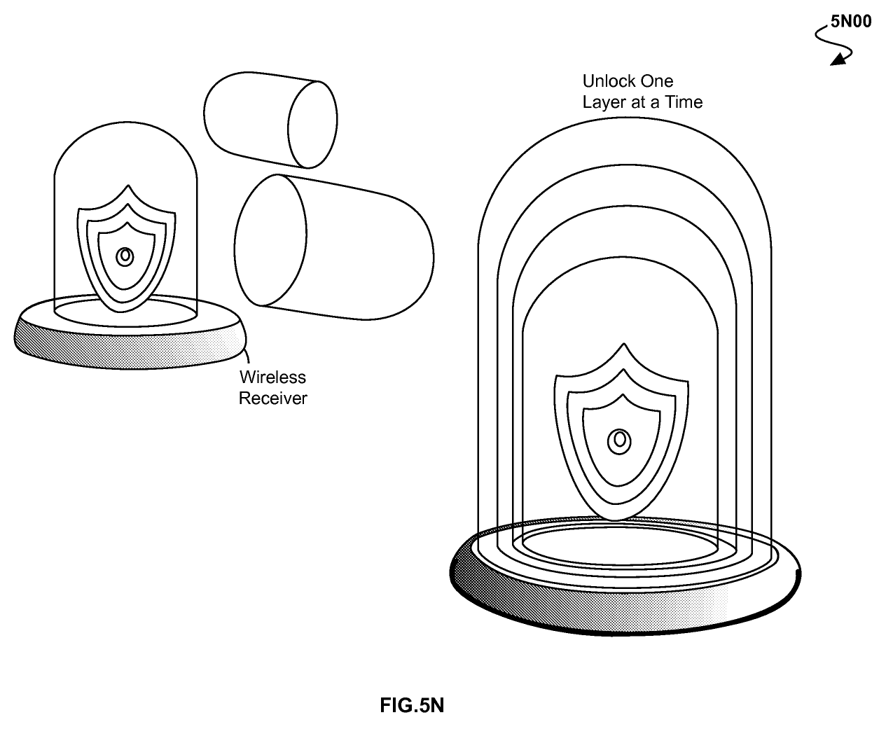

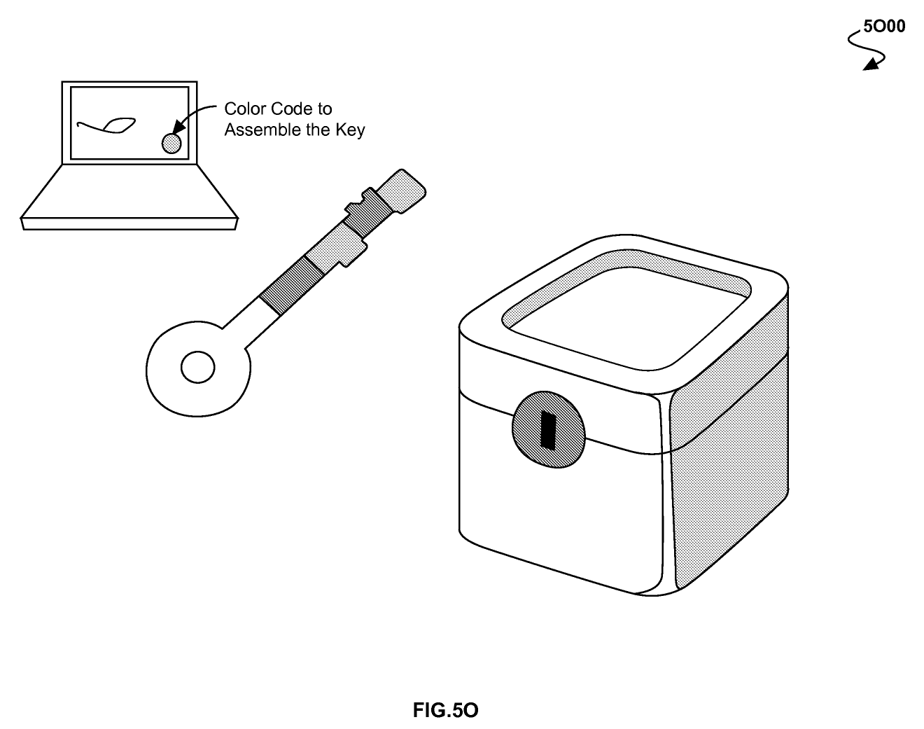

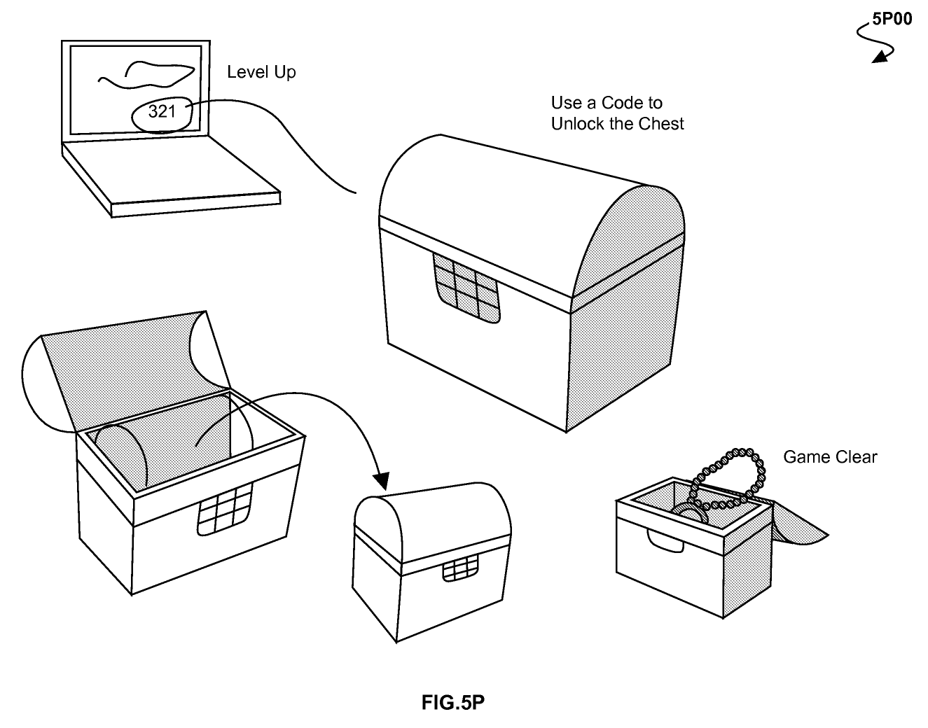

FIG. 5A shows a concentric component physical design of a morphing game peripheral for use within a system for n-way communication with and between locking/unlocking morphing game peripherals, according to one embodiment. As an option, design of FIG. 5A may be implemented in the context of the architecture and functionality of FIG. 1 through FIG. 10 herein. In particular, the design of FIG. 5A might be included in environments 100 or 200. Of course, however, the design of FIG. 5A may be included in any desired environment. As per the exemplary implementation shown, the game peripheral design is implemented in the form of a transforming concentric component puzzle. Of course a game peripheral may be embodied in the form of a badge, or in the form of any animate or any inanimate object, or it may be embodied in any other shape or likeness. In fact a game peripheral as disclosed herein may include multiple components and/or multiple physical design characteristics such as hinged mating, slidable mating, successively revealing components, protruding components, light-emitting components, removable components, and/or any forms of locking/unlocking components etc. For purposes of the disclosure herein, the term “badge” is used strictly as a convenient name for a game peripheral capable of changing shape and/or lighting and/or imagery. As shown, the design of FIG. 5A includes a base 520, an area for a label 510, an area for a visual screen 550 (e.g. LCD screen), one or more areas for additional visual feedback 530 (e.g. LEDs), and a second base portion 525. As shown, the second base portion serves as a chassis and housing for one or more audio devices 540 (e.g. buzzer, speaker, etc). As an option, the base 520 and/or the second base 525 may include an area for one or more buttons 560 or other human interface devices (e.g. momentary switches, capacitive switches, photocells, etc). In some embodiments the visible persistent change to the game peripheral includes positioning of base 525 with respect to base 520.

FIG. 5B shows a successively revealing physical design of a morphing game peripheral for use within a system for n-way communication with and between locking/unlocking morphing game peripherals, according to one embodiment. As an option, design of FIG. 5B may be implemented in the context of the architecture and functionality of FIG. 1 through FIG. 10 herein. In particular, the design of FIG. 5B might be included in environments 100 or 200. Of course, however, the design of FIG. 5B may be included in any desired environment. As per the exemplary implementation shown, the game peripheral design is implemented in the form of a revealing concentric component puzzle. In some embodiments the visible persistent change to the game peripheral includes unlocking the outermost component to reveal the next inner component.

FIG. 5C shows a sliding component physical design of a morphing game peripheral for use within a system for n-way communication with and between locking/unlocking morphing game peripherals, according to one embodiment. As an option, design of FIG. 5C may be implemented in the context of the architecture and functionality of FIG. 1 through FIG. 10 herein. In particular, the design of FIG. 5C might be included in environments 100 or 200. Of course, however, the design of FIG. 5C may be included in any desired environment. As per the exemplary implementation shown, the game peripheral design is implemented in the form of a slidably-mated multi-component character. In some embodiments the visible persistent change to the game peripheral includes unlocking hinged appendages of the character.

FIG. 5D shows a hinged component physical design of a morphing game peripheral for use within a system for n-way communication with and between locking/unlocking morphing game peripherals, according to one embodiment. As an option, design of FIG. 5D may be implemented in the context of the architecture and functionality of FIG. 1 through FIG. 10 herein. In particular, the design of FIG. 5D might be included in environments 100 or 200. Of course, however, the design of FIG. 5D may be included in any desired environment. As per the exemplary implementation shown, the game peripheral design is implemented in the form of a hinged multi-component character. In some embodiments the visible persistent change to the game peripheral includes unlocking a hinge to simulate the movement of a jawbone.

FIG. 5E shows a light-emitting physical design of a morphing game peripheral for use within a system for n-way communication with and between locking/unlocking morphing game peripherals, according to one embodiment. As an option, design of FIG. 5E may be implemented in the context of the architecture and functionality of FIG. 1 through FIG. 10 herein. In particular, the design of FIG. 5E might be included in environments 100 or 200. Of course, however, the design of FIG. 5E may be included in any desired environment. As per the exemplary implementation shown, the game peripheral design is implemented in the form of a light-emitting weapon. In some embodiments the visible persistent change to the game peripheral includes a pattern of light-emitting devices, which pattern changes based on game state.

FIG. 5F shows a light-emitting, concentric component physical design of a morphing game peripheral for use within a system for n-way communication with and between locking/unlocking morphing game peripherals, according to one embodiment. As an option, design of FIG. 5F may be implemented in the context of the architecture and functionality of FIG. 1 through FIG. 10 herein. In particular, the design of FIG. 5F might be included in environments 100 or 200. Of course, however, the design of FIG. 5F may be included in any desired environment. As per the exemplary implementation shown, the game peripheral design is implemented in the form of a light-emitting badge. In some embodiments the visible persistent change to the game peripheral includes a pattern of light-emitting devices, which pattern changes based on game state. In some cases, the number and/or color of the rings relates to the game state corresponding to a game level of achievement. The light-emitting badge may be worn about the neck, and may include an ON/OFF switch for power conservation.

FIG. 5G shows a protruding component physical design of a morphing game peripheral for use within a system for n-way communication with and between locking/unlocking morphing game peripherals, according to one embodiment. As an option, design of FIG. 5G may be implemented in the context of the architecture and functionality of FIG. 1 through FIG. 10 herein. In particular, the design of FIG. 5G might be included in environments 100 or 200. Of course, however, the design of FIG. 5G may be included in any desired environment. As per the exemplary implementation shown, the game peripheral design is implemented in the form of a pet with protruding appendages. In some embodiments the visible persistent change to the game peripheral includes a pattern of protruding appendages, which pattern changes based on game state.

FIG. 5H shows a successively revealing, hinged, concentric component physical design of a morphing game peripheral for use within a system for n-way communication with and between locking/unlocking morphing game peripherals, according to one embodiment. As an option, design of FIG. 5H may be implemented in the context of the architecture and functionality of FIG. 1 through FIG. 10 herein. In particular, the design of FIG. 5H might be included in environments 100 or 200. Of course, however, the design of FIG. 5H may be included in any desired environment. As per the exemplary implementation shown, the game peripheral design is implemented in the form of a pet with protruding appendages. In some embodiments the visible persistent change to the game peripheral includes a pattern of successively revealing, hinged, concentric components in a pattern, which pattern changes based on game state.

FIG. 5I shows a removable component physical design of a morphing game peripheral for use within a system for n-way communication with and between locking/unlocking morphing game peripherals, according to one embodiment. As an option, design of FIG. 5I may be implemented in the context of the architecture and functionality of FIG. 1 through FIG. 10 herein. In particular, the design of FIG. 5I might be included in environments 100 or 200. Of course, however, the design of FIG. 5I may be included in any desired environment. As per the exemplary implementation shown, the game peripheral design is implemented in the form of a pet with protruding appendages. In some embodiments the visible persistent change to the game peripheral includes one or more removable components, which removability changes based on game state.

FIG. 5J shows a light-emitting, arrayed component physical design of a morphing game peripheral for use within a system for n-way communication with and between locking/unlocking morphing game peripherals, according to one embodiment. As an option, design of FIG. 5J may be implemented in the context of the architecture and functionality of FIG. 1 through FIG. 10 herein. In particular, the design of FIG. 5J might be included in environments 100 or 200. Of course, however, the design of FIG. 5J may be included in any desired environment. As per the exemplary implementation shown, the game peripheral design is implemented in the form of a bracelet with light-emitting segments. In some embodiments the visible persistent change to the game peripheral includes a pattern of light-emitting segments which pattern changes based on game state. In some cases, the number and/or color of the segments relates to the game state corresponding to a game level of achievement. The light-emitting bracelet may be worn about the wrist, and may include an ON/OFF switch for power conservation.

FIG. 5K shows an arrayed light-emitting, protruding component physical design of a morphing game peripheral for use within a system for n-way communication with and between locking/unlocking morphing game peripherals, according to one embodiment. As an option, design of FIG. 5K may be implemented in the context of the architecture and functionality of FIG. 1 through FIG. 10 herein. In particular, the design of FIG. 5K might be included in environments 100 or 200. Of course, however, the design of FIG. 5K may be included in any desired environment. As per the exemplary implementation shown, the game peripheral design is implemented in the form of a character with protruding segments. In some embodiments the visible persistent change to the game peripheral includes a pattern of protrusion which pattern changes based on game state.

FIG. 5L shows a sliding, protruding component physical design of a morphing game peripheral for use within a system for n-way communication with and between locking/unlocking morphing game peripherals, according to one embodiment. As an option, design of FIG. 5L may be implemented in the context of the architecture and functionality of FIG. 1 through FIG. 10 herein. In particular, the design of FIG. 5L might be included in environments 100 or 200. Of course, however, the design of FIG. 5L may be included in any desired environment. As per the exemplary implementation shown, the game peripheral design is implemented in the form of a character with protruding segments. In some embodiments the visible persistent change to the game peripheral includes a pattern of protrusion which pattern changes based on game state.

FIG. 5M shows an arrayed hinged component physical design of a morphing game peripheral for use within a system for n-way communication with and between locking/unlocking morphing game peripherals, according to one embodiment. As an option, design of FIG. 5M may be implemented in the context of the architecture and functionality of FIG. 1 through FIG. 10 herein. In particular, the design of FIG. 5M might be included in environments 100 or 200. Of course, however, the design of FIG. 5M may be included in any desired environment. As per the exemplary implementation shown, the game peripheral design is implemented in the form of a puzzle with hinged components. In some embodiments the visible persistent change to the game peripheral includes a positioning of hinged components which positioning changes based on game state. In some cases, the position of the hinged components relates to the game state corresponding to a game level of achievement.

FIG. 5N shows a successively revealing physical design of a morphing game peripheral for use within a system for n-way communication with and between locking/unlocking morphing game peripherals, according to one embodiment. As an option, design of FIG. 5N may be implemented in the context of the architecture and functionality of FIG. 1 through FIG. 10 herein. In particular, the design of FIG. 5N might be included in environments 100 or 200. Of course, however, the design of FIG. 5N may be included in any desired environment. As per the exemplary implementation shown, the game peripheral design is implemented in the form of a puzzle with successively revealing components. In some embodiments the visible persistent change to the game peripheral includes a pattern of successively revealing components, which pattern changes based on game state.

FIG. 5O shows a keyed revealing physical design of a morphing game peripheral for use within a system for n-way communication with and between locking/unlocking morphing game peripherals, according to one embodiment. As an option, design of FIG. 5O may be implemented in the context of the architecture and functionality of FIG. 1 through FIG. 10 herein. In particular, the design of FIG. 5O might be included in environments 100 or 200. Of course, however, the design of FIG. 5O may be included in any desired environment. As per the exemplary implementation shown, the game peripheral design is implemented in the form of a puzzle with at least one key for revealing components. In some embodiments the visible persistent change to the game peripheral includes a pattern of unlocking for revealing components, which pattern changes based on game state.

FIG. 5P shows a successively revealing physical design of a morphing game peripheral for use within a system for n-way communication with and between locking/unlocking morphing game peripherals, according to one embodiment. As an option, design of FIG. 5P may be implemented in the context of the architecture and functionality of FIG. 1 through FIG. 10 herein. In particular, the design of FIG. 5P might be included in environments 100 or 200. Of course, however, the design of FIG. 5P may be included in any desired environment. As per the exemplary implementation shown, the game peripheral design is implemented in the form of a puzzle with key for revealing components. In some embodiments the visible persistent change to the game peripheral includes a pattern of unlocking compartments for revealing successive compartments, which pattern of unlocking changes based on game state.

### Configurations of Systems and Methods

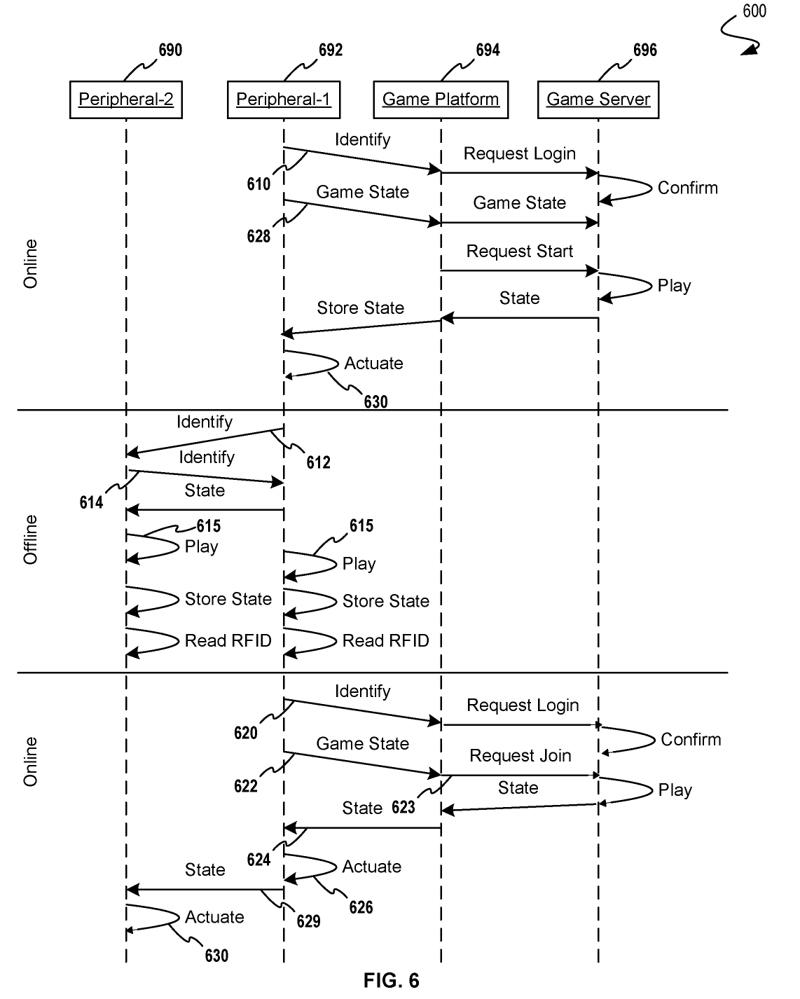

FIG. 6 depicts exemplary online interactions between morphing game peripherals 692 and 690, a game platform 694 and a game server 696. As shown, the present system 600 may be implemented in the context of the architecture and functionality of FIG. 1 through FIG. 5P. In particular, system 600 might be implemented within environments 100 or 200. Of course, however, the system 600 may be included in any desired environment. Additionally FIG. 6 depicts exemplary interactions between two morphing game peripherals in standalone (i.e. offline) mode. As shown, Peripheral-1 initiates communication with the game platform 694 via an identification and credentialing message (see Identify message 610). In turn, the game platform requests login to the game server 696 (see Request Login message), and once credentials are confirmed (see Confirm operation), and optional upload of game state from previous play has been completed (see Game State message 628), game play is enabled, and the game server 696 is ready for a request to start from the user of the game platform (see message Request Start). Upon a successful Request Start message the game server initiates play interaction with the game platform (see Play operations). In turn, the game state is stored at the game peripheral (see Store State message) and a visible persistent change to the game peripheral is actuated (See Actuate 630).

While online, and during any Play operation (or any other time within a login session for that matter) a player might meet other players, or a player might encounter (i.e. come into proximity with) other players, which players might be ‘foes’ (i.e. with respect to game play), or they might be ‘friends’ (i.e. with respect to game play). Strictly as an example, a player may come into proximity with another player, formerly a friend who has diminished with regard to degree of friendship or trust, or perhaps has even become a foe. Any of the aforementioned changes in state (e.g. identifying a friend, establishing a trust level, identifying a foe, changing level of friendship) may be retained during and after game play on the game server, and may further be communicated to the morphing game peripheral (see State message) and stored onto the morphing peripheral (see Store State message). That is, at points during play or when the play session is suspended or ends, game state (possibly including statistics) is provided to the game platform (see State message). In turn, the game state is stored at the game peripheral (see Store State message) and a visible persistent change to the game peripheral is enabled. As earlier described, such a visible persistent change to the game peripheral might include locking/unlocking components such that actuator apparatus 325 is enabled based on the game state. The aforementioned sequence of messages may transpire while the play interaction is in the online mode; that is, whenever the game server 696 participates in message exchanges with a game platform 694 via the Internet.

FIG. 6 also depicts exemplary methods for morphing of a game peripheral after resuming communications with an online game server having multiple game states. In some embodiments 33 game play can be initiated spontaneously by establishing a connection between the game peripheral and the online game server (see messages Identify, Request Login, and Request Start). The game server 696 may respond to such a resume request by associating the game peripheral with at least one game state (see message Request Join, message Confirm and operation Play). In embodiments, at least one of a game platform 694 or an Internet-enabled game peripheral 692, 694 is operable for retrieving from the online game server at least one bit for downloading to the game peripheral, wherein the at least one bit represents at least a portion of the at least one game state (see message State and message Store State). As can be understood from the description of this embodiment, the game server serves to download state whenever the game server recognizes a game state or a change in a game state that is to be downloaded. In particular, since the server can autonomously send a state message, neither a game platform nor a game peripheral need explicitly issue any state request message in order to serve for retrieving from the online game server the game state for actuating an electromechanical component of the game peripheral.

FIG. 6 also depicts exemplary offline interactions between a game peripheral (see Peripheral-1 692), and another game peripheral (see Peripheral-2 690) in an offline mode. In an offline mode (e.g. when there is no operable direct or indirect Internet connection with a game peripheral), Peripheral-1 and Peripheral-2 are capable of sending and receiving messages wirelessly via one or more of a wide range of protocols (e.g. instant messaging, IR COMMS protocols, TCP/IP, UDP, serial codes, etc). As shown, Peripheral-1 sends its identity to Peripheral-2 (see message Identify 612), and Peripheral-2 sends its identity to Peripheral-1 (see message Identify 614). Having thus established peer-to-peer identity, the game peripherals are each operable to carry out play instructions, possibly under at least partial command by the game peripheral holder, possibly using any or all I/O and user controls 144. In this manner, characteristics stored in a game peripheral can be known or shared or traded by and with the peer game peripheral. Of course some operations of play (see operations Play 615) may alter game state on one or both game peripherals. In particular, while offline, a player with a game peripheral might meet other players also with a game peripheral who become friends. Or a player may determine that another player, formerly a friend has diminished with regard to degree of friendship, or perhaps has even become a foe, and such a diminished friendship status might be recorded in a game peripheral and or operated upon by the user (e.g. through use of any one or more of the buttons and/or other user interfaces on/in the game peripheral). Strictly as an example, proximity of an entity (e.g. friend or foe) might be detected by a game peripheral, and the proximity of such an entity might then be displayed on the game peripheral, possibly with an invitation the game peripheral owner to alter the status of the relationship with the entity in proximity. Any of the aforementioned changes in state (e.g. identifying a friend, identifying a foe, changing level of friendship, identifying a foe, or otherwise altering the status of the relationship) may be retained on/in a game peripheral, and may later be communicated when an uplink is available. Moreover, any altering the status of the relationship (or other state changes for that matter) may be retained on/in a game peripheral, and such a change operable to produce at least one visible persistent change to the game peripheral. In some embodiments, when the game peripheral holders return to an online mode (see message Identify 620), for example by reconnecting the game peripheral to a personal computer, or a game console or to a docking station, the game peripherals can provide game state (see message Game State 622) via uplink to the game server, and the game state as stored during a period of offline mode play is uploaded to the game server (see Game State and Request Start, and Request Join messages). As previously indicated, the notion of game state as stored during a period of offline mode play might include state related to status of a relationship. As is recognized by those skilled in the art, since a game peripheral contains a unique ID, the holder of a game peripheral can be unambiguously associated with a particular entity. Such an upload of game state (see message 622) and a request to re-join game play (see message Request Join 623) might result in a game state changing event, and the game server might provide state (see message 624) to a game peripheral, which in turn might actuate (see Actuate operation 626). Still more, in a domino effect, a changed state in (for example) game peripheral 692 might result in a game state message (see State message 629) being sent from one game peripheral to another game peripheral in proximity.

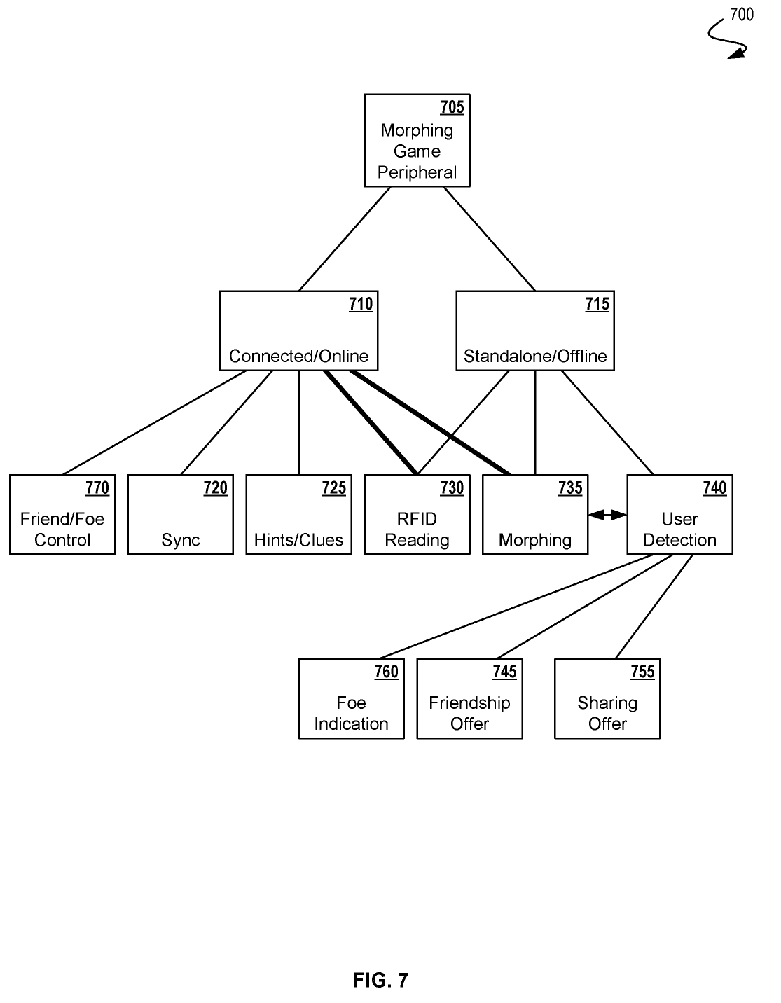

FIG. 7 depicts a hierarchy of modes and operations under a morphing game peripheral 705 that may interoperate with a game server or a social network server or a virtual world server (i.e. in the online mode 710), or may interoperate with other game peripherals (i.e. a peer-to-peer mode or standalone mode 715). FIG. 7 is purely exemplary. As shown, the present system 700 may be implemented in the context of the architecture and functionality of FIG. 1 through FIG. 6. In particular, system 700 might be included in environments 100 or 200. Of course, however, the system 700 may be included in any desired environment. As shown a game peripheral may interact in an online mode, performing at least such operations as synching data 720, requesting or displaying hints or clues 725, reading (optional) RFID tags 730, etc. In the standalone mode, a game peripheral is operable for user detection 740 of other game peripherals in proximity, offering the possibility of a friendship 745, indicating foe (or friend) status 760, offering sharing of inventory 755, etc. Of course some operations may be performed regardless of the mode, though some operations are operable only when in online mode, and some operations are operable only when in standalone mode. In addition to communications between game peripherals and other game peripherals and communications between game peripherals and game consoles, game peripherals are operable to read tokens. For example, given a game peripheral with an RFID reader, a game peripheral is operable to read an RFID tag from a token. A token may have the form of a card (RFID card) or key (RFID key) or puzzle piece, or any other game piece, whether RFID-enabled or not or whether the reading mechanism is RFID or some other technology. Strictly for ease of exemplifying communications, Table 1 shows sample game peripheral interactions with its environment.

As shown, operation 760 serves in standalone mode to provide indications of proximity of a friend or foe. Of course, any of the indications discussed above (e.g. using any or all I/O and user controls 144) may be used for indication of the nature (e.g. friend or foe nature) of the identified entity.

TABLE 1
Game peripheral interaction

| | | With Another Game | |
|---|---|---|---|
| Mode | With a Game Server | Peripheral | With a Token |
| Online | Activate | Another player joins | Read token ID |
| (server | Login | at same game console | Store token ID |
| client) | State synchronization | Identify proximity | |
| | State upload (from | Modify friendship | |
| | game peripheral) | state | |
| | State download (to | | |
| | game peripheral) | | |
| | Hint download | | |
| | Identify proximity | | |
| | Modify friendship | | |
| | state | | |
| Offline | Local communications | Identify, Share or | Read token ID |
| (peer- | | Trade state | Store token ID |
| to-peer) | | Identify proximity | |
| | | Modify friendship | |
| | | state | |

Now, with an understanding of the operation of a game peripheral with its environment, exemplary play (e.g. in game play or in real life or in virtual world life) can be expressed as follows:

1. Online
a. Login and enter training area. Collect any new state since last online visit, optionally using a web page or other screen device.
b. Pick up hints, pick up and store provisions, learn.
c. Perform game actions, possibly using and storing game artifacts or accoutrement.
d. Feed game or virtual world characters.
e. Monitor and store game stats or virtual world characteristics via visible symbols on the game peripheral.
f. Upload new game or virtual world state.
g. Identify friend or foe.
h. Display friend/foe icons, alerts, warnings.
i. Mate-up action between two game peripherals that have each been actuated into a particular visible and persistent state.

2. Offline
a. Peer-up with other players via game peripheral-to-game peripheral communications.
b. Use game peripheral-to-game peripheral communications to make friends in the offline world, then carry the friendship into an online world.
c. Exchange hints, provisions, and/or other ideas with peers.
d. Play mini-games to win currency, change status, amass inventory, etc. from peers.
e. Buy tokens, game routes, game secrets, artifacts or accoutrement.
f. Scan tokens with a game peripheral.
g. Assemble a map with tokens.
h. Assemble a puzzle with tokens.
i. Identify friend or foe.
j. Display friend/foe icons, alerts, warnings.
k. Modify status of social relationship.
l. Mate-up action between two game peripherals t have each been actuated into a particular visible and persistent state.

In some embodiments RFID tokens can also be combined or permuted by scanning in a particular order (see Table 2).

TABLE 2
Interactions with tokens

| Example Scan Events | Example Result | Comment |
|---|---|---|
| TokenA, TokenB, TokenC | Flying ability | |
| TokenB, TokenA, TokenC | Underwater breathing | Note: This example shows |
| | | scanning order recognition. |
| TokenA1, TokenA2, TokenA3 | Stronger power of ‘A’ | Note This example shows that |
| | | TokenA1 is distinguishable from |
| | | TokenA2, and from TokenA3, etc. |
| TokenP1 | Add indicated known | Parental controls regime might |
| | user to “black list” | include a token for approval or |
| | | disapproval of friends. |
| TokenP2 | Remove indicated | Parental controls regime might |
| | known user from | include a token for approving a |
| | “black list” | previously disapproved friend. |

Of course, tokens can be reused/rescanned over time, thus this and other reusability characteristics may extend the life of a token to a plurality of use events.

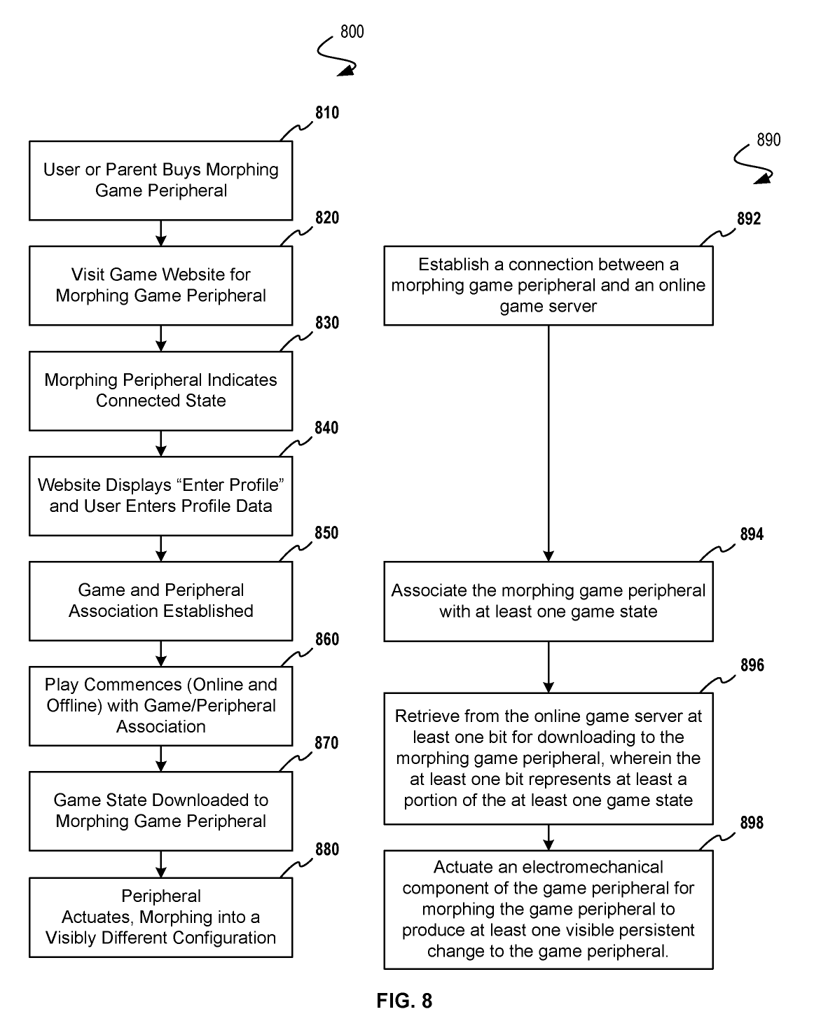

FIG. 8 is a depiction of methods for use within a system for n-way communication with and between locking/unlocking morphing game peripherals, according to some embodiments. As an option, the present methods 800 and/or 890 may be implemented in the context of the architecture and functionality of FIG. 1 through FIG. 7. In particular, methods 800 and/or 890 might be included in environments 100 or 200. Of course, however, the methods 800 and/or 890 may be included in any desired environment. As shown, the operations 810, 820, 830, 840, 850, 860, 870, 880, 892, 894, 896, and 898 may each be executed independently and/or concurrently, so long as the requirements for initial or continued operation of a specific operation or sub-operation have been satisfied. In one possible execution of operations, a user or parent might purchase a morphing game peripheral, possibly also with one or more RFID tags (see operation 1810). The user in turn might connect the game peripheral to a game console, and visit a game peripheral-enabled website (see operation 820). Such a game peripheral-enabled website might be specific to the game peripheral or tag, or it might be a morphing game peripheral-enabled website affiliated in some other way (e.g. via syndication, federation, feed, etc) to a native game peripheral-enabled website specific to the game peripheral or tag. The game peripheral, now connected to a game peripheral-enabled website might indicate a “connected” state (see operation 830). The game console or uplinked website might indicate the option for a profile to be entered (see operation 840) at which time a user might enter (or establish) an initial association profile (see operation 850). The user might then play online games, visit social networking sites, establish push/pull feeds, make friends (online or offline or both), and otherwise interact via an uplink or via local peer-to-peer communication (see operation 860). Of course, as disclosed above, a user's offline state is stored in a game peripheral, and is synchronizable when an uplink is available (e.g. when the morphing game peripheral is connected to a game console or router or other uplink); thus, at some point, the states resident in a user's game peripheral can be uploaded, and made available for a variety of accesses including a download of game state to the morphing game peripheral (see operation 870), which operation then serves to actuate a morphing game peripheral into a visibly different configuration (880).

In a slightly different configuration of the operations of method 800, a first game peripheral might establish communication with, and retrieve state from, a second game peripheral (see operation 870) and in response to the state retrieved, actuate an electromechanical component of the first game peripheral for morphing the first game peripheral, wherein the morphing of the first game peripheral produces at least one visible persistent change to the first game peripheral.

As an option, the system 890 may be implemented in the context of the architecture and functionality of FIG. 1 through FIG. 7. In particular, method 890 might be included in environments 100 or 200. Of course, however, the method 890 may be included in any desired environment. As shown, the operations 892, 894, 896, and 898 may each be executed independently and/or concurrently, so long as the requirements for initial or continued operation of a specific operation or sub-operation have been satisfied. In one possible execution of operations, a method for morphing of a game peripheral during interaction with an online game server having multiple game states might include operations for establishing a connection between a first game peripheral and an online game server (see operation 892), associating the game peripheral with at least one game state (see operation 894), retrieving from the online game server at least one state bit for downloading to the game peripheral (see operation 896), and actuating an electromechanical component of the game peripheral for morphing the game peripheral (see operation 898) thus producing at least one visible persistent change to the game peripheral.

### Configurations Using Social Networking Servers

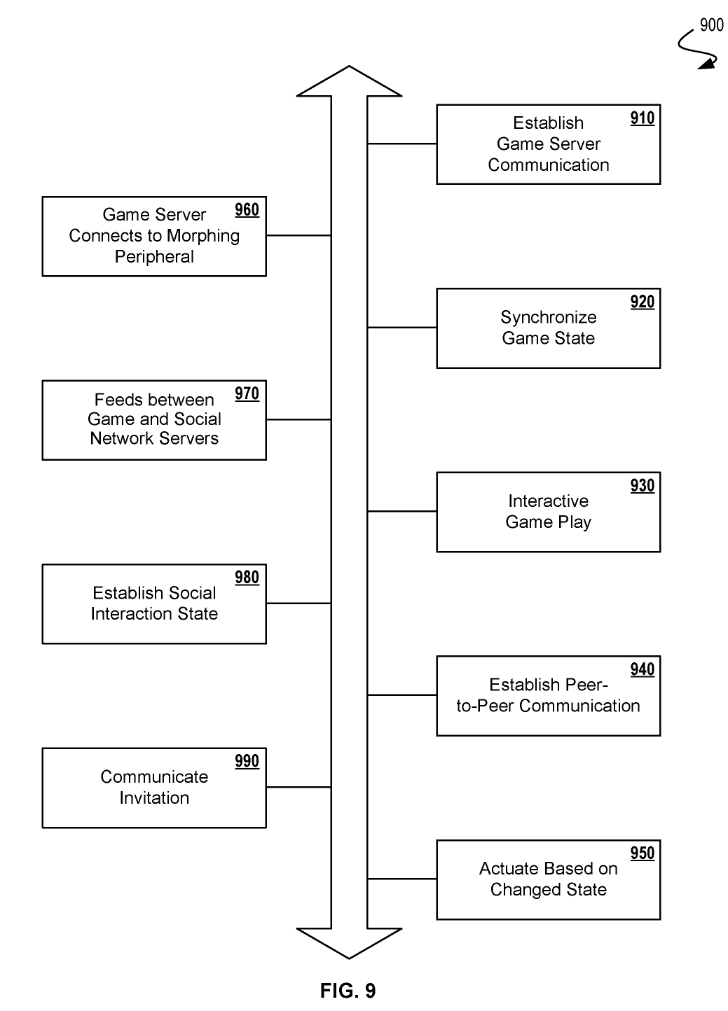

FIG. 9 is a depiction of a system 900 for use within a system and method for n-way communication with and between locking/unlocking morphing game peripherals, according to one embodiment. As an option, the present system 900 may be implemented in the context of the architecture and functionality of FIG. 1 through FIG. 8. In particular, system 900 might be included in environments 100 or 200. Of course, however, the system 900 may be included in any desired environment. As shown the operations 910, 920, 930, 940, 950, 960, 970, 980, and 990 may each be executed independently and/or concurrently, so long as the data requirements for a specific operation or sub-operation have been satisfied. The system might begin by establishing a connection between a first game peripheral and a game platform for communicating to a virtual world server (see operation 910). Given then such a connection, operation 920 is operable for synchronizing with the virtual world server or morphing game peripheral. In this embodiment, the establishment of the connection from operation 910 and the possible bidirectional synchronization performed in operation 920 meets the requirements for interactive game play (see operation 930). At any point in time, operation 940 might execute, thus establishing a second connection for communicating between a first game peripheral and a second game peripheral for peer-to-peer communication. Data might then be exchanged between the first game peripheral and the second game peripheral, resulting in storing game state in the game peripheral in the form of at least one bit retrieved from the peer. At still some moment later, the game state stored by the execution of operation 960 might be uploaded to a game server during another execution of operation 920.

The game peripheral might also be actuated (see operation 950), which actuation might occur asynchronously with other events between a game server and/or including one or more social network servers (see operation 970). Such feeds or other communications between a game server and one or more social network servers serve to import/export friend/foe status as well as import/export status between social networking sites. Of course, as earlier indicated, and since the state of friends and aspects of social interactions can be stored in a game peripheral (see operation 980), an event involving online or offline game play or social interaction can trigger an actuation response (e.g. morphing, change of display, or any sort of visible, persistent friend/foe indication) by the game peripheral (see operation 950). Such a state can be recorded in the game peripheral as a part of game state, and later be uploaded to a game server (see operation 920). As used hereinabove, the terminology “game server” and “virtual world server”, and “social network server” refer generally to the same apparatus, namely, a “server” and are used herein interchangeably when referring to the structure of the apparatus known as a “server”.

### Configurations Using a Network of Computers

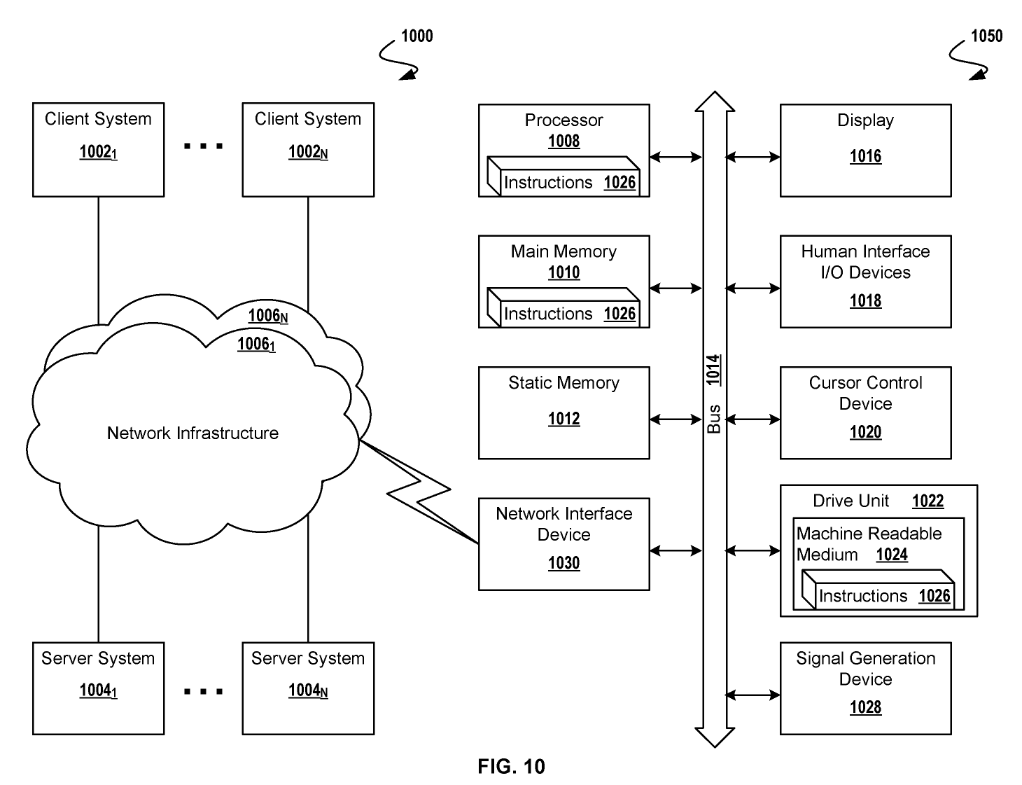

FIG. 10 is a diagrammatic representation of a network (system 1000) and a machine (system 1050) in the exemplary form of a computer system, within which a set of instructions may be executed, according to one embodiment. As an option, the present system 1000 may be implemented in the context of the architecture and functionality of FIG. 1 through FIG. 9. In particular, system 1000 might be included in environments 100 or 200. Of course, however, the system 1000 may be included in any desired environment. As shown FIG. 10 depicts a network 1000, including nodes for client computer systems 1002₁ through 1002_{N}, nodes for server computer systems 1004₁ through 1004_{N}, nodes for network infrastructure 1006₁ through 1006_{N}, any of which nodes may comprise a machine 1050 within which a set of instructions for causing the machine to perform any one of the techniques discussed above may be executed. The embodiment shown is purely exemplary, and might be implemented in the context of one or more of the figures herein.

Any node of the network 1000 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1050 includes a processor 1008 (e.g. a processor core, a microprocessor, a computing device, etc), a main memory 1010 and a static memory 1012, which communicate with each other via a bus 1014. The machine 1050 may further include a display unit 1016 that may comprise a touch-screen, or a liquid crystal display (LCD), or a light emitting diode (LED) display, or a cathode ray tube (CRT). As shown, the computer system 1050 also includes a human input/output (I/O) device 1018 (e.g. a keyboard, an alphanumeric keypad, etc), a pointing device 1020 (e.g. a mouse, a touch screen, etc), a drive unit 1022 (e.g. a disk drive unit, a CD/DVD drive, a tangible computer readable removable media drive, an SSD storage device, etc), a signal generation device 1028 (e.g. a speaker, an audio output, etc), and a network interface device 1030 (e.g. an Ethernet interface, a wired network interface, a wireless network interface, a propagated signal interface, etc).

The drive unit 1022 includes a machine-readable medium 1024 on which is stored a set of instructions (i.e. software, firmware, middleware, etc) 1026 embodying any one, or all, of the methodologies described above. The set of instructions 1026 is also shown to reside, completely or at least partially, within the main memory 1010 and/or within the processor 1008. The set of instructions 1026 may further be transmitted or received via the network interface device 1030 over the network bus 1014.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical, acoustical or other form of propagated signals (e.g. carrier waves, infrared signals, digital signals, etc); or any other type of media suitable for storing or transmitting information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method for morphing of a game peripheral during interaction with an online game server having multiple game states comprising:
establishing a connection between a first game peripheral and the online game server;
associating the first game peripheral with at least one game state;
retrieving from the online game server at least one bit for downloading to the first game peripheral, wherein the at least one bit represents at least a portion of the at least one game state; and
actuating an electro-mechanical component of the first game peripheral for morphing the first game peripheral, wherein the morphing of the first game peripheral produces at least one visible persistent change to the first game peripheral.

2. The method of claim 1, further comprising:
retrieving from a second game peripheral at least one bit for downloading to the first game peripheral, wherein the at least one bit represents at least a portion of the at least one game state; and
actuating an electro-mechanical component of the first game peripheral for morphing the first game peripheral, wherein the morphing of the first game peripheral produces at least one visible persistent change to the first game peripheral.

3. The method of claim 1, wherein the associating includes identification by a login protocol.

4. The method of claim 1, wherein the associating includes identification through input via a screen device.

5. The method of claim 1, wherein the associating includes associating a game state with a unique game peripheral identification tag.

6. The method of claim 1, wherein the establishing a connection includes a connection to a personal computer.

7. The method of claim 1, wherein the establishing a connection includes a connection to a wireless router.

8. The method of claim 1, wherein the establishing a connection is performed spontaneously.

9. The method of claim 1, wherein the establishing a connection results in at least one of, a visual alert, an audible alert.

10. The method of claim 1, wherein the associating the first game peripheral with at least one game state results in at least one of, a visual alert, an audible alert.

11. The method of claim 1, wherein the retrieving from the online game server includes at least one bit representing state retrieved from a social networking site.

12. The method of claim 1, wherein the actuating an electro-mechanical component includes actuating at least one of a plurality of concentric components.

13. The method of claim 1, wherein the actuating an electro-mechanical component includes actuating an unlocking mechanism for revealing a plurality of concentric components.

14. The method of claim 1, wherein the actuating an electro-mechanical component includes actuating at least one slide-ably mated component.

15. The method of claim 1, wherein the actuating an electro-mechanical component includes actuating at least one hinged component.

16. The method of claim 1, wherein the actuating an electro-mechanical component includes actuating at least one protruding component.

17. The method of claim 1, wherein the actuating an electro-mechanical component includes actuating at least one light-producing component.

18. A apparatus for morphing of a game peripheral during interaction with an online game server having multiple game states comprising:
a module for establishing a connection between a first game peripheral and the online game server;
a module for associating the first game peripheral with at least one game state;
a module for retrieving from the online game server at least one bit for downloading to the first game peripheral, wherein the at least one bit represents at least a portion of the at least one game state; and
a module for actuating an electro-mechanical component of the first game peripheral for morphing the first game peripheral, wherein the morphing of the first game peripheral produces at least one visible persistent change to the first game peripheral.

19. The apparatus of claim 18, further comprising:
a module for retrieving from a second game peripheral at least one bit for downloading to the first game peripheral, wherein the at least one bit represents at least a portion of the at least one game state; and
a module for actuating an electro-mechanical component of the first game peripheral for morphing the first game peripheral, wherein the morphing of the first game peripheral produces at least one visible persistent change to the first game peripheral.

20. A computer readable medium for storing instructions, which when executed by a computer, causes the computer to morph a game peripheral during interaction with an online game server having multiple game states, said instructions for:
establishing a connection between a first game peripheral and the online game server;
associating the first game peripheral with at least one game state;
retrieving from the online game server at least one bit for downloading to the first game peripheral, wherein the at least one bit represents at least a portion of the at least one game state; and
actuating an electro-mechanical component of the first game peripheral for morphing the first game peripheral, wherein the morphing of the first game peripheral produces at least one visible persistent change to the first game peripheral.
